(19) United States
(12) Patent Application Publication
(10) Pub. No.: US 2022/0405870 A1
(43) Pub. Date: Dec. 22, 2022

(54) LAND MANAGEMENT AND RESTORATION

(71) Applicant: Vibtant Planet PBC, Incline Village, NV (US)

(72) Inventors: Scott CONWAY, Incline Village, NV (US); Danielle O. Dierker, Reno, NV (US); Galton Wells Miller, Seattle, WA (US)

(73) Assignee: Vibtant Planet PBC, Incline Village, NV (US)

(21) Appl. No.: 17/842,713

(22) Filed: Jun. 16, 2022

Related U.S. Application Data
(60) Provisional application No. 63/211,921, filed on Jun. 17, 2021.

(51) Int. Cl. G06Q 50/16; G06V 20/13

(52) U.S. Cl. CPC G06Q 50/163; G06Q 50/165; G06V 20/13

(57) ABSTRACT

Provided herein are systems and methods for identifying a recommended treatment to land. An example method comprises: identifying a plurality of sites of interest in the land; segmenting the land into a plurality of areas based on ownership information and ecological information; identifying, for a particular area of the plurality of areas, a plurality of potential treatments; calculating a performance metric for each of the plurality of potential treatments to obtain a plurality of performance metrics for the particular area, wherein each performance metric of the plurality of performance metrics is calculated based on one or more sites of interest located in the particular area; and selecting the recommended treatment for the particular area of the land from the plurality of potential treatments based on the plurality of performance metrics.

### CROSS-REFERENCE TO RELATED APPLICATION

This application claims the benefits of U.S. provisional application No. 63/211,921, filed Jun. 17, 2021, the contents of which are incorporated herein by reference in its entirety for all purposes.

### FIELD

The present disclosure relates generally to land management and restoration, and more specifically to systems and methods for identifying recommended treatment(s) to a land.

### BACKGROUND

Forests and agricultural lands could drawdown more than all the carbon humans emit each year. However, past approaches to land management have caused these landscapes to emit more carbon dioxide than they store. Currently, the process of land restoration project planning is slow, inefficient, and expensive. Accordingly, there is a need for techniques for efficiently identifying recommended land treatments using an automated, uniform, consistent, and comprehensive approach and providing the recommended land treatments in an intuitive manner.

### BRIEF SUMMARY

A computer-implemented method of identifying a recommended treatment to a land is disclosed. The computer-implemented method comprises: identifying a plurality of sites of interest in the land; segmenting the land into a plurality of units based on one or more of: ownership information or ecological information; identifying, for a particular unit of the plurality of units, a plurality of potential treatments; calculating a performance metric for each of the plurality of potential treatments to obtain a plurality of performance metrics for the particular unit, wherein each of the plurality of performance metrics is calculated based on one or more sites of interest located in the particular unit; and selecting the recommended treatment for the particular unit of the land from the plurality of potential treatments based on the plurality of performance metrics. Additionally or alternatively, in some embodiments, the computer-implemented method further comprises: selectively collecting data related to the land, wherein the data comprises one or more of: anthropogenic data, physical data, or biologic data. Additionally or alternatively, in some embodiments, the computer-implemented method further comprises: generating, based on the collected data, map data indicating ownership and special land designation status of a plurality of portions of the land. Additionally or alternatively, in some embodiments, the one or more sites of interest include one or more of: primary residential structures, non-residential structures, emergency infrastructure, utility infrastructure, water resources infrastructure, communication infrastructure, critical access roads, fuel breaks, strategic fuel areas, areas of critical plant and animal species habitat, large tree groves, nest and den sites, cultural sites, recreational trails, campgrounds, special/unique ecological features, ecological commodities, or scientific monitoring sites. Additionally or alternatively, in some embodiments, the computer-implemented method further comprises: performing disturbance assessment on the land to generate a plurality of disturbance maps corresponding to a plurality of disturbance types, wherein each of the plurality of disturbance maps includes one or more disturbance values for one or more sites of interest on the land. Additionally or alternatively, in some embodiments, the computer-implemented method further comprises: performing ecological function assessment on the land to determine treatment effects on the one or more sites of interest located in the particular unit, wherein each of the plurality of performance metrics for the particular unit is associated with the corresponding determined treatment effects. Additionally or alternatively, in some embodiments, each of the plurality of units is owned by a single entity and has a uniform biophysical composition. Additionally or alternatively, in some embodiments, the performance metric for each of the plurality of potential treatments is a treatment-specific restorative return on investment (RROI) value calculated by: calculating one or more site-specific RROI values for the one or more sites of interest located in the particular unit; and aggregating the one or more site-specific RROI values. Additionally or alternatively, in some embodiments, each of the one or more site-specific RROI values is calculated based on a site-specific post-disturbance value change, a site-specific post-treatment post-disturbance value change, and a site-specific change in disturbance effects. Additionally or alternatively, in some embodiments, the computer-implemented method further comprises: calculating, for the recommended treatment, a contribution value of the recommended treatment for each of a plurality of objectives. Additionally or alternatively, in some embodiments, the computer-implemented method further comprises: obtaining one or more user inputs indicative of relative importance of the plurality of objectives. Additionally or alternatively, in some embodiments, the computer-implemented method further comprises: formulating a plan for implementing the selected recommended treatment; and displaying or automatically executing the plan. Additionally or alternatively, in some embodiments, the computer-implemented method further comprises: applying pillar contribution values to the one or more sites of interests located in the particular unit, wherein each pillar contribution value is based on resilience of the one or more sites of interest located in the particular unit to the corresponding pillar. Additionally or alternatively, in some embodiments, identifying the plurality of potential treatments and selecting the recommended treatment are performed for each of the plurality of units. Additionally or alternatively, in some embodiments, the computer-implemented method further comprises: receiving user inputs indicative of user selections of a plurality of scenarios, the plurality of scenarios associated with the plurality of units; and providing a visual comparison of the plurality of scenarios. Additionally or alternatively, in some embodiments, the user inputs further indicate priorities, the method further comprises: weighting the plurality of scenarios in accordance with the priorities. Additionally or alternatively, in some embodiments, at least one of the plurality of scenarios comprises a scenario created by another user. Additionally or alternatively, in some embodiments, the computer-implemented method further comprises: administering the recommended treatment to the particular unit of the land.

An electronic device is disclosed. The electronic device comprises: one or more processors; a memory; and one or more programs, wherein the one or more programs are stored in the memory and configured to be executed by the one or more processors, the one or more programs including instructions for: identifying a plurality of sites of interest in the land; segmenting the land into a plurality of units based on one or more of: ownership information or ecological information; identifying, for a particular unit of the plurality of units, a plurality of potential treatments; calculating a performance metric for each of the plurality of potential treatments to obtain a plurality of performance metrics for the particular unit, wherein each of the plurality of performance metrics is calculated based on one or more sites of interest located in the particular unit; and selecting the recommended treatment for the particular unit of the land from the plurality of potential treatments based on the plurality of performance metrics.

A non-transitory computer-readable storage medium storing one or more programs is disclosed. The one or more programs comprises instructions, which when executed by one or more processors of an electronic device having a display, cause the electronic device to perform operations for: identifying a plurality of sites of interest in the land; segmenting the land into a plurality of units based on one or more of: ownership information or ecological information; identifying, for a particular unit of the plurality of units, a plurality of potential treatments; calculating a performance metric for each of the plurality of potential treatments to obtain a plurality of performance metrics for the particular unit, wherein each of the plurality of performance metrics is calculated based on one or more sites of interest located in the particular unit; and selecting the recommended treatment for the particular unit of the land from the plurality of potential treatments based on the plurality of performance metrics.

### DESCRIPTION OF THE FIGURES

The present application can be understood by reference to the following description taken in conjunction with the accompanying figures.

FIG. 1 depicts an example software platform for identifying a recommended treatment to a land, in accordance with some embodiments.

FIG. 2 illustrates an example digital surface model (DSM) and an example digital terrain model (DTM), in accordance with some embodiments.

FIG. 3 depicts deriving canopy height information based on DSM and DTM, in accordance with some embodiments.

FIG. 4 depicts example treatment data map units, in accordance with some embodiments.

FIGS. 5A and 5B depict an example automated process for restorative return on investment (RROI) optimization, in accordance with some embodiments.

FIGS. 6A and 6B depict example processes for the restoration calculation, in accordance with some embodiments.

FIGS. 7A-15B depict example user interfaces, in accordance with some embodiments.

FIG. 16 depicts an example electronic device, in accordance with some embodiments.

### DETAILED DESCRIPTION

The following description sets forth example systems, methods, parameters and the like. It should be recognized, however, that such description is not intended as a limitation on the scope of the present disclosure but is instead provided as a description of example embodiments.

Disclosed herein are systems, methods, electronic devices, and non-transitory storage media for identifying a recommended treatment to a land. Embodiments of the present disclosure include techniques for efficiently identifying recommended land treatments using an automated, uniform, consistent, and comprehensive approach and providing the recommended land treatments in an intuitive manner.

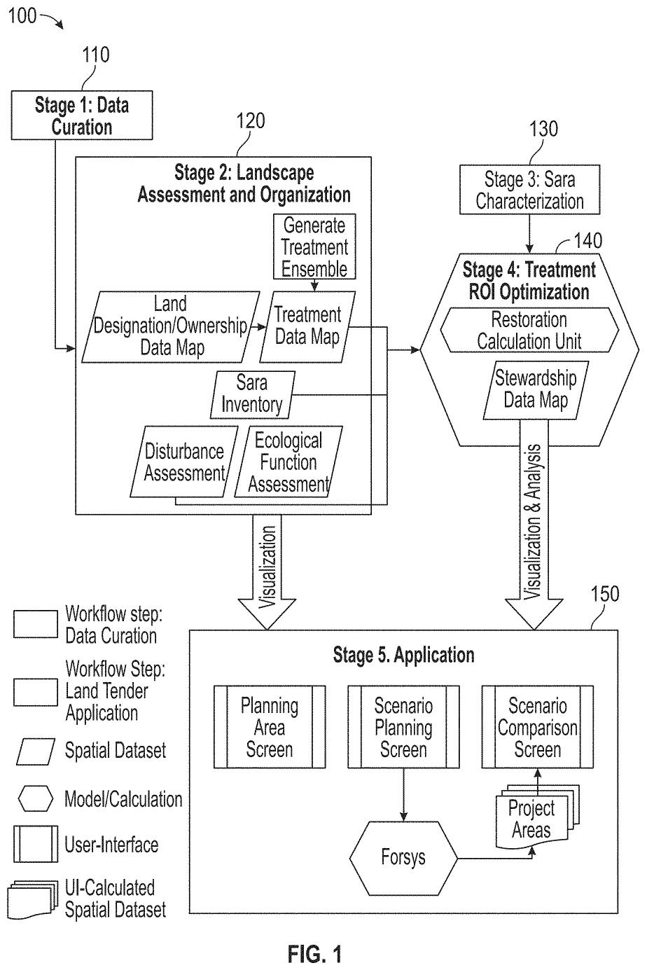

FIG. 1 depicts an example software platform for identifying a recommended treatment to a land, in accordance with some embodiments. The system 100 may comprise a plurality of stages, such as Stage 1 (110) for data curation, Stage 2 (120) for landscape assessment and organization, Stage 3 (130) for sites of interest characterization, Stage 4 (140) for treatment return on investment (ROI) optimization, and Stage 5 (150) for application for project orientation and sequencing. At Stage 1, various data can be collected from a plurality of resources for a given landscape. Stage 1 may provide the collected data to Stage 2.

At Stage 2, the system generates, based on the collected data, a land designation/ownership data map corresponding to the landscape. The land designation/ownership data map can be a map indicating ownership and special land designation status of a plurality of portions of the land (e.g., boundaries). For example, the land designation/ownership data map includes information indicating various portions of the land (e.g., defined by boundaries) and the corresponding ownership information of the various portions of the land. For example, the given land may include various portions belonging to different entities and can be marked as such in the land designation/ownership data map. The land designation/ownership data map can be initially generated through a manual or automatic process of combining data sources within a Geographic Information System (GIS). In some embodiments, the land designation/ownership data map may be updated through a combination of manual and automated processes.

The system identifies a plurality of sites of interest. The plurality of sites of interest may be obtained from an inventory of sites of interest (referred to as strategic areas, resources, and assets (SARAs)) in the given land. In some embodiments, a site of interest is a location that involves anthropogenic, ecological, or an anthropogenic modification of an ecological resource (e.g., plantation) that has been identified as having societal value, such as primary residential structures. In some embodiments, the SARA inventory comprises a dataset of one or more (e.g., all) mapped SARAs. Within the SARA inventory, each SARA is represented by its own geospatial “footprint” layer in vector format (e.g., mapped boundary), such as an ESRI Shapefile. For example, the given landscape may include a SARA corresponding to one or more (e.g., all) mapped primary residential structures within the given landscape. Mapped SARAs can be initially collected and generated through a manual or automatic process of combining data sources within a GIS. In some embodiments, the mapped SARAs may be updated through a combination of manual and automated processes.

The system also obtains (a) disturbance assessment(s) of the given landscape. There are various types of unplanned disturbances such as wildfire, insect and pathogen outbreaks, flooding, climate change, earthquake, etc. In some embodiments, the system obtains maps of each disturbance's probability and intensity. For example, the system can be provided a map corresponding to each disturbance, and the map indicates a probability intensity of that disturbance for each SARA. In some embodiments, mapped disturbances are typically generated through individually, relatively-automated processes external to the system, although some manual calibration may be involved.

The system obtains an ecological function assessment of the given land. In some embodiments, the ecological function assessment may be a conditional departure assessment. In some embodiments, the system compares the current vegetation state of the given land to a modeled historical reference condition. This provides information about the “departure” of current conditions from modeled historical reference conditions or from some target (e.g., optimal) reference conditions. The information can help to inform where treatments could provide benefit by reducing the departure. This can be represented from a number of metrics, including fire return interval departure, etc. The ecological function assessment and classification can be generated through an automated process, although some manual inputs and calibration may be involved.

The system obtains a treatment data map. The treatment data map can be a map of landscape metrics and treatment information. In some embodiments, the treatment data map is made up of a plurality (e.g., up to or more than hundreds of thousands) of units (e.g., ecologically-based units). In some embodiments, each unit (e.g., ecologically-based unit) is relatively uniform in its biophysical, vegetation structure and land designation/ownership data map class composition. There may be one or more SARAs on each unit (e.g., ecologically-based unit). For example, a uniformly-forested landscape unit may include three SARAs (e.g., a house, a water source, a significant plant species). The treatment data map units are generated through an automated process.

In the treatment data map, a particular landscape unit can be associated with one or more types of structure metrics, such as forest structure metrics (e.g., average canopy height, tree diameter, ladder fuels), disturbance and forest health metrics (e.g., vegetation departure, fire hazard, drought hazard), descriptive/topographic attributes (e.g., average slope, ownership), etc. The treatment data map units are populated with these metrics through an automated process.

After the treatment data map is developed, each unit (e.g., ecologically-based unit) can then be attributed with information regarding vegetation management treatments including, but not limited to, potential treatment methods, the impact of treatments on disturbance intensities, treatment probabilities, cost of treatments, product and biomass removal, etc. The treatment data map units are assigned potential initial and follow-up treatments, along with recommended maintenance treatments, through an automated process using a developed ruleset, based upon slope, ownership, presence of sensitive SARAs, etc. For example, for a treatment data map unit that has greater than 10% of its area covered by a California Spotted Owl Protected Activity Center and its vegetation and slope characteristics meet some other criterion, one recommended treatment could be hand-thinning. Stage 2 provides a treatment data map to Stage 4. Stage 2 also provides Disturbance Assessment(s) and Ecological Function Assessment(s) to Stage 5. In some embodiments, the Disturbance Assessment(s) and Ecological Function Assessment(s) may be inputs to prioritization. The disturbance assessment(s) may map and quantify the probability and intensity (e.g., severity) of disturbances. The ecological function assessment(s) may provide the baseline ecological function of a unit. In some embodiments, the ecological function assessment(s) may indicate the amount of available room for improvement.

At Stage 3, the system generates SARA characterization information. In some embodiments, a relative potential socio-ecological (ROSE) score is generated that may be uniform or variable across one or more (e.g., all) occurrences of that particular SARA within the given area (e.g., all water sources in the given land). In some embodiments, SARAs can be grouped into a plurality of objectives. In some embodiments, response functions are designed to quantify the effects of planned and unplanned disturbances on individual SARAs. After Stage 3, each SARA contains information about its ROSE, how it contributes to different management objectives, and how its value changes in response to different disturbances and treatments. SARA ROSE values (also referred to as ROSE scores) are initially assigned through a manual or automatic process in an objective framework but are spatially-distributed in an automated process. SARA contributions to management objectives are determined through an objective classification framework. In some embodiments, specific SARA classifications are assigned manually. SARA response functions can be initially generated through a manual or automatic process. Stage 3 provides one or more scores (e.g., ROSE scores) to Stage 4.

At Stage 4, the system receives outputs from a treatment RROI algorithm. A recommended treatment is output for each unit in the treatment data map (described in Stage 2) that results in the best net benefit to one or more (e.g., all) SARAs contained within each landscape unit in terms of both avoided or reduced loss from disturbance(s) as well as ecological-function improvement. Other packaged metrics associated with the socio-ecological effects of treatment are also packaged for each treatment data map unit, as well as economic cost of treatment. The RROI algorithm and optimal treatment assignment may be automated processes.

For each treatment of a treatment data map unit, the restoration calculation algorithm calculates the performance metric (e.g., site-specific RROI) for one or more sites of interest located in a particular area. For example, the restoration calculation algorithm may calculate SARA RROIs for the SARAs on the treatment data map unit. For example, if the treatment data map unit comprises one water source, four residential structures, and 10 critical access roads (thus 15 SARAs), the system can calculate 15 SARA RROIs. One or more site-specific (e.g., the 15 SARA) RROIs can be aggregated (e.g., take the sum, average, mean, median, etc.) to calculate the treatment RROI for the particular area. For example, if there are five potential treatments for the treatment data map unit, the system can calculate five treatment RROIs. These five RROIs are then compared to select the treatment with the maximum RROI as the recommended treatment for the treatment data map unit.

To determine a treatment (e.g., best or optimal treatment) during Stage 4, the system calculates the performance metric (e.g., treatment-specific RROI value) for each of a plurality of potential treatments for one or more (e.g., each) landscape units through an automated process called the restoration calculation algorithm. For example, the treatment data map may include a particular landscape unit associated with a plurality of treatments (e.g., five treatments), as described in Stage 2. An RROI value for each of the plurality of treatments is calculated, and the treatment that has the maximum benefit (for example, maximum RROI or maximum RROI per treatment cost dollar) among the plurality of treatments is selected as the recommended treatment.

Further, the system packages treatment and stewardship metrics and characteristics for each given treatment data map unit. Example treatment and stewardship metrics may include RROI, the subcomponents of RROI (e.g., Treatment Effects and Change in Disturbance Effects), treatment (initial and follow-up treatments recommended from the previous step), treatment costs, and total product removal (e.g., the amount of wood that can be harvested from the treatment within that particular unit). This is conducted through an automated process.

Once these steps have been completed for each treatment data map unit, one or more (e.g., all) values for one or more (e.g., all) units are joined back to the treatment data map, resulting in a stewardship data map. In some embodiments, the stewardship data map may be a treatment data map populated with specific information about treatment and stewardship metrics for each landscape unit. This is conducted through an automated process.

At Stage 5, the system provides a user-interface with a plurality of screens for displaying and analyzing various pieces of information about the landscape. The system allows the user to visualize information aggregated from Stages 2 and 3 (e.g., SARAs, disturbances, etc.) on a planning area screen. In some embodiments, the system may generate prioritized vegetation management projects using information from the stewardship data map along with several user-inputs through an automated process. Analysis and comparison of these projects is also possible within the user-interface using, e.g., a scenario planning screen, a scenario comparison screen, or both.

The systems and methods disclosed herein are directed to a particular improvement in identifying a recommended treatment to a land. As discussed in more detail throughout this disclosure, the performance metrics for the plurality of potential treatments are calculated and the recommended treatment is selected based on a selected subset of the data that is curated (e.g., in Stage 1) and identified sites of interest. By using a selected subset of the curated data and making a selection based on the identified sites of interest, the systems and methods simplify the calculations, thereby avoiding or reducing any hindrance on computational performance or any excess usage of data storage (e.g., in memory) due to the reduced amount of data. Once the recommended treatment is selected, it may be applied to the land. In some embodiments, the recommended treatment may be automatically applied by a control system. For example, the selected recommended treatment may be to plant more seeds (to improve vegetation), where a control system may automatically cause one or more machines (e.g., drones) to drop the seeds on the land. Embodiments of the disclosure may include formulating a plan for implementing the recommended treatment, and displaying and/or automatically executing the plan. For example, the selected recommended treatment may be to install drip irrigation for a plot of land. The plan may comprise determining the legal restrictions and rules for the land, designing the irrigation layout (e.g., a drip tube every 400 feet), ordering the drip tubing and other equipment (e.g., drip emitter, micro-sprinkler heads, etc.), and scheduling the installation.

Stage 1: Data Curation

At Stage 1, anthropogenic, physical, and biologic data can be collected from a plurality of resources. The purpose of this data collection stage is to build datasets that are representative of the biophysical landscape, land ownership and uses, and any other relevant information such as structures, trails, emergency infrastructure, habitat, etc. In some embodiments, some or all of the data is associated with a spatial element (e.g., a location tag). In Stage 2, the collected information is used to build datasets (the SARA Inventory, land designation/ownership data map, disturbance probabilities/exposure and intensities, treatment opportunities, and the treatment data map). Example data sources and datasets for the system are described further below. It should be noted that the disclosed datasets and data sources are examples and that the software platform may use other types of datasets and data sources.

Example data sources or resources include federal and local government agencies, non-profit organizations, companies, or any combination thereof. In some embodiments, the plurality of resources include the U.S. Forest Service, the Sierra Fund, CAL FIRE, county-specific resources, water agencies, power companies, fire departments, and private organizations. The information can be collected using a plurality of sensors (e.g., LiDAR sensors) and vehicles (e.g., drones). The specific data source can depend on availability of the data as well as the specific need of data for the system.

Anthropogenic data can comprise various land attributes, such as use information, infrastructure information, structures information, ownership information, social information, etc. Use information can include the use of a land area (e.g., whether it is a mining site, a plantation, etc.). Infrastructure information can include emergency infrastructure, water infrastructure, communications infrastructure, and power infrastructure, etc. Structures information can include building footprints, plans, maps, etc. Ownership information can include data related to land ownership and allocation. Social information can indicate whether a land area has a special purpose (e.g., cultural site, recreation site).

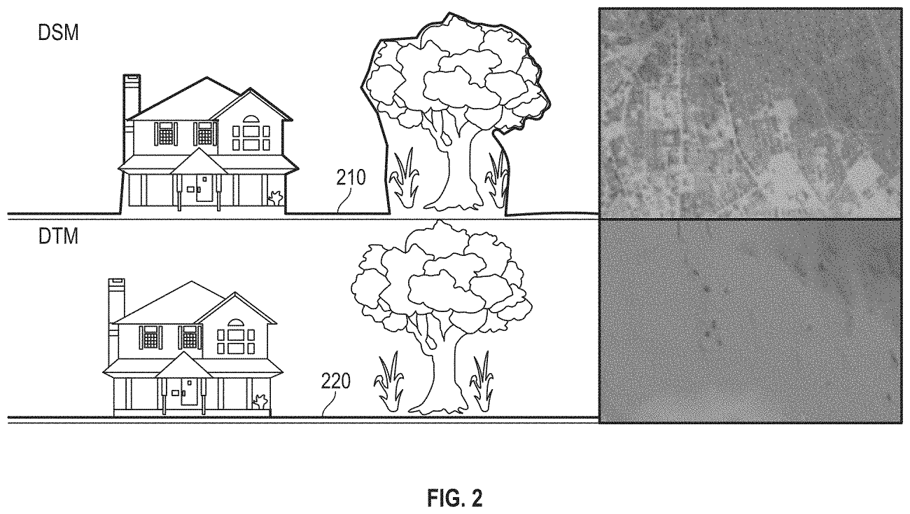

Physical data can comprise climate information, digital elevation models (DEMs) (also referred to as digital terrain models (DTMs), digital surface models (DSMs), etc. The climate information can include historical and projected climate and hydrology data, precipitation, climate water deficient, actual evapotranspiration, temperature, future climate scenarios, etc. In some embodiments, the climate information can be obtained from the Basin Characterization Model (BCM), Cal Adapt, Climate Engine, etc. DEMs can include water body delineation, topographic wetness index, heat load index, topographic position index, aspect, elevation, hill shade, etc. The DEM data can be derived from a plurality of sensors, such as LiDAR sensors. DSMs can include various surface elevation information that can be derived from sensors. FIG. 2 illustrates an example DSM and an example DTM (source: https://www.satpalda.com/blogs/3d-landscape-dsmdtm-service), in accordance with some embodiments.

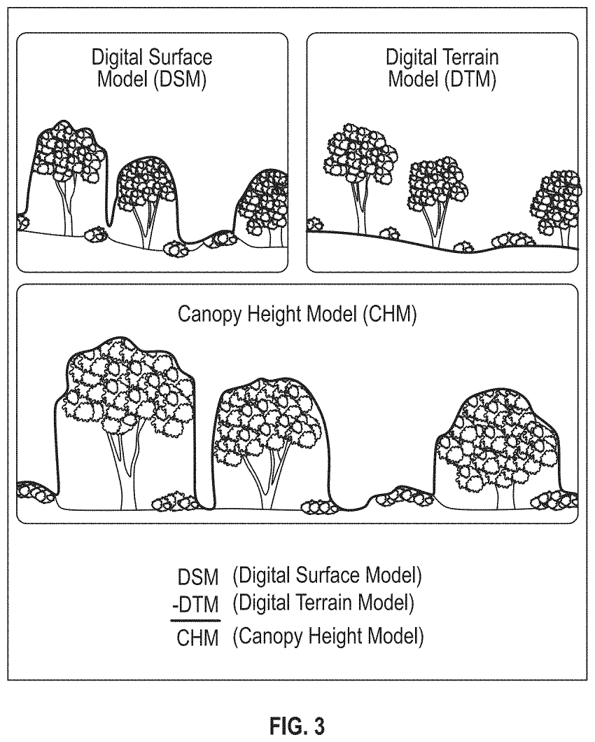

Biologic data can comprise canopy cover information, canopy height information, fuel metrics, ecology information (e.g., wildlife, vegetation), tree lists, etc. Canopy cover information can be in various canopy cover metrics (e.g., above 2 meters, 2-8 meters, 8-16 meters, 16-32 meters, above 32 meters). Canopy height information such as the canopy height model (ChM) may be derived from DSM and DTM, as shown in FIG. 3 (https://www.neonscience.org/resources/learning-hub/tutorials/chm-dsm-dtm-gridded-lidar-data).

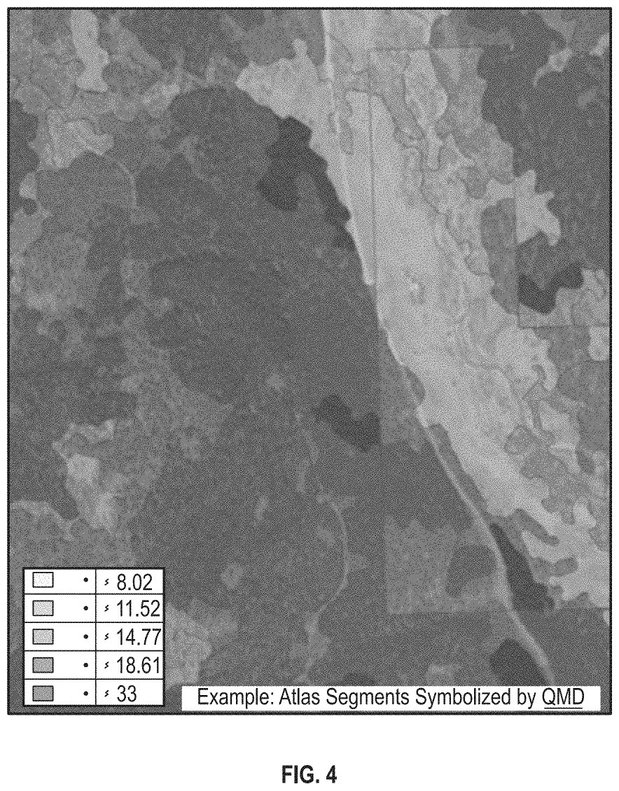

Fuel metrics include one or more (e.g., all) metrics for running contemporary and operationalized fire models. Most fire models use a landscape file (.lcp), which can comprise topographic vegetation (e.g., canopy cover, stand height, canopy bulk density, canopy base height, surface fuel model), and fuel inputs. Although these inputs can come from a variety of sources, most fire modeling data repositories package them for the user (e.g., LandFire, California Forest Observatory (CFO)). Fire models may include other input datasets and parameters, such as one or more of: ignition location inputs (e.g., specific scenario building with single ignitions, probabilistic generation with multiple random ignitions), water inputs, weather (e.g., wind speed, wind direction, humidity), or topographic information (e.g., elevation, slope, aspect). FIG. 4 depicts various types of fuels, in accordance with some embodiments.

One or more (e.g., all) geospatial data is processed within a GIS (such as ESRI's ArcMap product), quantum geographic information system (QGIS), a translation and manipulation package (such as point data abstraction library (PDAL) or geospatial data abstraction library (GDAL)), or the like. In some embodiments, geospatial data processing may comprise projecting spatial data, merging datasets associated with like-features (e.g., combining two datasets with campground information), removing duplicate features, etc.

In some embodiments, part or all of the data is transformed from the source dataset(s) to make it useful to the planning process. Transformations include conforming the data by correcting or normalizing geo-coordinates for different geo-reference points or different geometric distortions originating in the sensor equipment, platform operation, or other factors. In some embodiments, the data may be transformed to account for conversion of units.

More elaborate transformations include deriving or estimating detailed model parameters such as forest canopy height, tree species, and other metrics from generic sensor data such as satellite imagery, including multi-spectral imagery or other sources. One means to derive detailed model parameters is through machine learning, using a model trained from explicit measurements of the desired parameters in samples of the region of interest (e.g., through LIDAR sensors or manual surveys) and then using the machine-learned model to fill in the areas not explicitly measured.

Another means is to use a stochastic process to synthesize plausible metric sets that fit or match one or more (e.g., all) measured data. This is used when the available data is low resolution or insufficiently accurate for the subsequent processes to utilize, but when an approximation or guess is useful for planning. This is particularly useful when generating comparisons at a regional scale (or other larger scale) and detailed plans at a local scale (or other smaller scale).

Stage 2: Landscape Assessment and Organization

Stage 2 involves assessment of certain components and states of the landscape of interest. Example steps performed in Stage 2 include generating the land designation/ownership data map to map ownership and land use designations, generating the SARA inventory to map strategic areas, resources, and assets, performing disturbance assessment to map and quantify the probability and intensity of landscape-scale unplanned disturbances such as wildfire, and performing ecological function assessment to map and quantify how the current conditions (e.g., vegetation state) compare to historical or reference conditions. A final and critical output of Stage 2 is the treatment data map, which packages landscape metrics (e.g., detailed vegetation structure, ownership, slope, climate, hydrology, soils, etc.) and treatment information into units (e.g., ecologically-based units) on the landscape. One or more (e.g., all) of the individual components of Stage 2 can involve use of models and a GIS, described further below.

Land Designation/Ownership Data Map

The land designation/ownership data map is a map showing ownership and special land designation boundaries (for example, National Wilderness Area boundaries). The map may be associated with one or more tags indicative of ownership and/or special land designation boundaries. The land designation/ownership data map may be a piece of information used to create the treatment data map and may provide spatial context for how treatments are recommended across the landscape.

The land designation/ownership data map is built using data collected in Stage 1 along with a GIS (such as ESRI's ArcMap software or open-source QGIS software), quantum geographic information system (QGIS), a translation and manipulation package (such as point data abstraction library (PDAL) or geospatial data abstraction library (GDAL)), or the like. The number of ownership classifications is dependent on the landscape, but can include ownership classes such as National Forest System land, National Wilderness Preservation System areas, and large landowners (e.g., a single entity such as a landowner owns greater than a designated threshold of total cumulative acres). Smaller private landowners are typically, but not always, grouped into a single class (for example, “Private small landowners (less than 10 acres)”) within the land designation/ownership data map.

SARA Inventory

SARAs are sites/areas that are anthropogenic, ecological, or an anthropogenic modification of an ecological resource (e.g., plantation) that have been identified as having societal value. In some embodiments, a SARA may have the following properties:

1. Have the ability to be mapped with some precision,

2. Can affect and be affected by unplanned disturbances (e.g., wildfires) and planned disturbances (e.g., treatments, such as prescribed fire), or

3. Have societal value (not just personal value)

Embodiments of the disclosure may comprise one or more types of sites of interest (e.g., SARAs) depending upon the landscape. The plurality of sites of interest may include one or more of: primary residential structures, non-residential structures, emergency infrastructure, utility infrastructure, water resources infrastructure, communication infrastructure, critical access roads (e.g., ingress/egress routes), fuel breaks, strategic fuel areas, areas of critical plant and animal species habitat, large tree groves, nest and den sites, cultural sites, recreational trails, campgrounds, special/unique ecological features, ecological commodities, or scientific monitoring sites.

The SARA Inventory is a dataset of one or more (e.g., all) mapped SARAs. Raw mapped SARA data are collected during Stage 1, and one or more (e.g., all) of the SARA geoprocessing is conducted within a GIS (such as ESRI's ArcMap software or open-source QGIS software), quantum geographic information system (QGIS), a translation and manipulation package (such as point data abstraction library (PDAL) or geospatial data abstraction library (GDAL)), or the like. Within the SARA Inventory, one or more (e.g., each) SARAs are represented by a corresponding geospatial “footprint” layer in vector format (e.g., mapped boundary) (such as an ESRI Shapefile). One or more geoprocessing steps may be involved in generating each SARA layer including, but not limited to, the following:

For SARAs made up of multiple datasets from different sources, datasets are combined, duplicate features are removed, etc.
The “footprint” of a SARA is simply the aerial extent of the feature (for example, the square foot footprint of a structure). In some cases, a “buffer” may be applied to a SARA feature in order to (1) create its footprint and/or (2) account for the area around the SARA where disturbances like fire would begin to have an impact on the SARA. The original dataset for a given SARA (collected during Stage 1) may comprise a set of discrete features represented as lines or points, and so the buffering step allows those features to be converted to polygons (e.g., “footprints”). A “buffer” may be an area around a feature. For example, a 100 foot buffer applied around a point would create a circle with a radius of 100 feet extending from the point at the center. The buffer distance is typically determined by one or more criteria:
   Minimum distance from the SARA where disturbances (such as fire) would impact the SARA: For example, fire can negatively affect a home when it is within 100 feet of that structure, so the features associated with the primary residential structures SARA may be buffered by 100 feet.
   Estimated average SARA dimensions: For example, cell tower data are typically represented as point features. The footprint of the cell towers can be estimated from the average height of a cell tower (e.g., 200 feet), so the buffer applied around the cell tower points to create polygon features would be 200 ft.
For certain types of raw SARA data, the feature may be buffered to generate the SARA footprint. For example, if campground location data are represented as points, simply applying a buffer to those points will likely not generate a footprint that is representative of the actual aerial extent of the campground. In these cases, a GIS or similar is used to manually digitize (e.g., create) the footprint using aerial imagery and other sources of information.

One or more landscapes may have a large number of SARAs. In some embodiments, SARAs are grouped into primary categories: Earth, Air, Fire, Water, and Assets. The purpose of grouping the SARAs is so that the system allows the user to toggle on and off layers and groups of layer in the application user-interface (UI). Within the UI (described further in Stage 5), these primary groupings may be further broken down into secondary groupings, and additionally or alternatively, further into the individual SARA. In some embodiments, a SARA may have multiple datasets/factors making up the SARA. The primary groupings, secondary groupings, and individual factors may be organize the SARAs within the UI. The primary category groupings may be:
Earth: While all SARAs could fall into the Earth category, these are ecological resources that are not air, water, fire, or assets. Earth includes SARAs that are considered vegetation (e.g., meadow), wildlife (e.g., bird or habitat for a bird), or other (e.g., limestone cave).
Fire: These are ecological SARAs that actively (versus passively) influence fire on the landscape. For example, a fuel break designed to actively influence fire dynamics would be considered part of the fire primary category. In contrast, the general forest would passively influence fire dynamics, and therefore would not be considered part of the under Fire primary category, but could be considered part of the Earth primary category.
Water: These are ecological SARAs that are either a water resource, or directly contribute to the health of a water resource.
Air: These are ecological SARAs that directly influence air quality and include resources that are tied to greenhouse gases.
Assets: These are SARAs that can be considered property. This includes both anthropogenic resources (e.g., structure) and/or ecological resources that are being used as an anthropogenic asset (e.g., plantation).

In some embodiments, SARA may be grouped into prioritization objective categories: Assets, Biodiversity, Carbon, Ecological Commodity, History & Knowledge, Recreation, Safety, and Water. The purpose of grouping SARAs into prioritization objective categorizes may be for the application user-interface (UI) in which layers and groups of layers may be toggled on and off.

Assets: These are SARAs that can be considered property. This includes both private assets (e.g., structure) and/or public resources that serve communities across the landscape (e.g., utilities).
Biodiversity: This category contains SARAs that contribute to a biodiverse ecosystem and include animal species/communities or their habitat (e.g., Marten), plant species/communities or their habitats (e.g., riparian areas) as well as landscape scale or holistic biodiversity information (e.g., habitat connectivity).
Carbon: These SARAs are directly related to carbon and include above-ground or below-ground carbon.
Ecological Commodity: Resources that have monetary value are included in this SARA category and can range from resources that can be extracted (e.g., mining or forest plantations) to resources that can be gathered from the landscape (e.g., mushroom foraging or hunting).
History & Knowledge: These are SARAs that either relate to cultural resource (e.g., historic or prehistoric sites), or contribute to ongoing scientific knowledge or operational management practices (e.g., weather stations, water monitoring stations).
Recreation: Facilities or infrastructure directly related to recreation areas and activities are included in this SARA category (e.g., campgrounds, trails).
Safety: Safety SARAs include assets, areas or zones that are directly related to public safety and would be utilized in the first response to an emergency (e.g., strategic fuel breaks).
Water: These are ecological SARAs that are either a water resource, or directly contribute to the health of a water resource (e.g., high erosion potential areas, rivers and waterbodies).

Disturbance Assessment

There are various types of unplanned disturbances such as wildfire; insect and pathogen outbreaks that can be due to drought vulnerability, etc.; flooding; climate change, which is an accelerant of other disturbances; blowdown, earthquake impact, etc. Within the system workflow, these disturbances are assessed in terms of their impact to SARAs, which include not only ecological resources, but also anthropogenic assets. The disturbances are characterized by their annualized probability or exposure of occurrence and the intensity of that occurrence. In some embodiments, the disturbance value of a given hazard can be equal to the probability multiplied by intensity: disturbance (hazard)=probability×intensity.

Hazard of disturbance is often thought of as negative, but within this framework, it is simply the likely occurrence of disturbances at varying intensities. In some embodiment, disturbance may be related to Risk (also often thought of as negative), which is discussed further in Stage 4. Risk may incorporate the exposure of landscape elements (e.g., SARAs) that have the potential to be impacted positively or negatively by the hazard. Disturbances such as wildfire and insect outbreaks due to drought vary spatially across the landscape, and are typically quantified through stochastic modeling to determine the probability and intensity of the disturbance itself.

Performing the Disturbance Assessment step on a land may result in generating a plurality of disturbance maps corresponding to a plurality of disturbance types. The plurality of disturbance maps may map each disturbance's probability or intensity. In some embodiments, each disturbance map includes one or more disturbance values for each site of interest on the land. The number and types of disturbances assessed will vary between landscapes. The process for assessing disturbances involves modeling using existing software or web-based applications and/or use of existing datasets. In some embodiments, one or more disturbance values may be used to determine the RROI values. Additionally or alternatively, the RROI values may be determined based on treatment effect, as a treatment may directly impact one or more objectives. For example, removing small trees (treatment) may improve water quantity (objective). A treatment may cause reduced or avoided losses, such as avoiding loss in water quality by preventing a high severity wildfire, as one non-limiting example.

Ecological Function Assessment

Departure from optimal functional conditions can be represented in a variety of ways to estimate current function. For example, current ecological function can be assessed by comparing the current vegetation state to its historical condition. This provides information about the “departure” of current conditions from historical conditions, and in the framework, helps to inform where treatments could provide benefits by reducing the vegetation departure. This can be represented from a number of metrics, including fire return interval departure, forest structure departure, presence of invasive species, etc. This information can be derived from existing datasets that may have been collected during Stage 1 (for example, LANDFIRE Vdep product from Historical Range of Variability (HRV) analysis conducted using the Landscape Disturbance and Succession (LDSM) modeling, etc.). Other types of departure proxy metrics may be more suitable for anthropogenic SARAs. Ultimately, departure metrics resulting from this step represent a percent departure. The percentage departure is then applied during Stage 4 to estimate SARA current conditions, as discussed in more detail below.

Treatment Data Map and Generate Treatment Ensemble

The treatment data map is a map of landscape metrics and treatment information. It is unique in that rather than representing this information in a grid format, the treatment data map is made up of a plurality (e.g., up to or more than hundreds of thousands) of units (e.g., ecologically-based units) (depending on the landscape) that are uniform in their biophysical and land designation/ownership data map class composition. A unit (e.g., an ecologically-based unit) can be derived from a number of attributes, but in this process, map include information on forest structure (e.g., tree stand height, quadratic mean diameter, canopy cover, ladder fuel) and topography data (e.g., slope, aspect), and climate, hydrology, and/or other data impacting the ecological behavior of the landscape. This way of packaging the landscape is critical for the hand-off from landscape vegetation management planning to actual on-the-ground implementation efforts in that it helps to minimize the amount of time that silviculturists and foresters spend delineating treatment areas. FIG. 4 is an example of treatment data map units. The shading represents the average quadratic mean diameter of the trees within each treatment data map unit.

The treatment data map may be generated from one or more steps:
1. Use a segmentation process to identify units (e.g., ecologically-based units) across the landscape (initial landscape segmentation process). When LiDAR data are available, it is possible to generate unit data (e.g., ecologically-based unit data) that have high fidelity to the observed conditions; this can be done using methods, such as an automated process (e.g., EcObject). When LiDAR data are not available, this process can be conducted using aerial imagery and a vegetation type map (such as LANDFIRE Existing Vegetation Cover). An automated process is described qualitatively below, and is an example of how units (e.g., ecologically-based units) could be developed using LiDAR data.
   a. Use LiDAR point cloud data to develop a canopy height model (CHM) where raster cell values represent the normalized above ground height of the vegetation surface. In some embodiments, methods such as a watershed segmentation model, which extracts the foreground and background of the landscape, may be used.
   b. The CHM is then used to identify Tree Approximate Objects (TAO) using tree segmentation methods such as the Watershed Segmentation Model. These are the first individual objects on the landscape, and are used to approximate individual trees.
   c. The CHM in combination with the TAOs is used to identify forest structure based on stand height. The result is clumped TAOs to identify similar groups of trees in single units. These units of clumped TAOs are larger than individual TAOs. Non-treed areas are segmented based on a combination of vegetation height and other meaningful vegetation boundaries on the landscape such as roads, streams, etc.
   d. The units of clumped TAOs are then further aggregated into large polygon units based on connected areas with similar forest structure and topographic characteristics. These large polygon units from this step are the largest in size.
2. Further refine units (e.g., ecologically-based units) based on climate, topographic, vegetation change, and/or land designation/ownership data map information. The large polygon units resulting from the initial landscape segmentation process can then be segmented into smaller polygon sub-units using (but not limited to) the information such as the following:
   Biophysical characteristics of a site (also called biophysical units, which represent five classes of how well a particular location can support biomass growth). Class 0 is not productive, and then classes 1-4 are scaled from the lowest to highest productivity sites.
   Watersheds (such as USGS hydrologic units or HUCs).
   Geophysical units representing clustered areas on the landscape with similar characteristics related to growing vegetation growing conditions (for example, precipitation, elevation, slope, and other variables).
   Any data about landscape change that may have occurred (such as fire, vegetation management treatments, etc.)
   Ownership or land designation information from the land designation/ownership data map
3. Populate the polygon sub-units with landscape metrics. As a final step, the resulting polygon sub-units from the refinement process in Step 2 may be populated with the following information about that particular landscape unit including, but not limited to, forest structure metrics (e.g., average canopy height, tree diameter, ladder fuels), disturbance and forest health metrics (e.g., vegetation departure, fire hazard, drought hazard, etc.), descriptive/topographic attributes (e.g., average slope, ownership, etc.), etc. In some embodiments, a polygon sub-unit may be a treatment data map unit.

After the treatment data map is developed, each unit (e.g., ecologically-based unit) can then be attributed with information regarding vegetation management treatments through an automated process that uses a treatment operability ruleset. This ruleset to assign treatment options and costs for each landscape may be developed based on expert knowledge (e.g., US Forest Service employee), information in peer-review journal articles, extrapolations from historical data captured from previous projects undertaken with this tool, a default set of predetermined values configured within the system, or other combination of data sources and models. The developed logic-based set of rules are used to assign potential recommendations for treatments (e.g., initial and follow-up treatments, maintenance treatment type) for each treatment data map unit. “Treatments” refer to activities related to vegetation management, such as (but not limited to) activities that remove vegetation to improve function (e.g., ecological function) and/or reduce wildfire risk, activities related to post-fire restoration (e.g., replanting), etc. In some embodiments, the logic-based set of rules may be a superset of rules comprising treatment operability.
“Initial treatment” refers to the first vegetation management treatment that would be performed at a given treatment data map unit. “Follow-up treatment” refers to the secondary treatment that would be performed at a given treatment data map unit.
“Maintenance treatment” refers to the treatment that conducted routinely at a given treatment data map unit in order to maintain desired conditions.
Inputs to the treatment operability ruleset are information that can operationally constrain the treatments that could occur for a given treatment data map unit on the landscape. Inputs may include, but are not limited to, vegetation, topographic, land use, and SARA information such as canopy cover, slope, land designation/ownership data map class, percent of area covered by discrete SARAs (e.g., structures, nest and den sites, etc.), wildfire burn severity.
Treatment options are then assigned through an automated process that tags each treatment data map unit with treatment options using the developed treatment operability ruleset.
The outputs from this treatment operability ruleset are ensembles of potential recommended initial and follow-up treatments, as well as a recommended maintenance treatment for each treatment data map unit. The treatment outputs may be specific to each treatment data map unit. Treatments are tagged with metadata such as probability of treatment, cost of treatment, product/biomass removal, etc. for use in a later treatment optimization process.

The information attributed to each unit is then input to Stage 4, where the final recommended initial and follow-up treatments are assigned to each treatment data map unit based upon the treatment that yields the highest RROI (described in the context of Stage 4).

Stage 3: SARA Characterization

Besides their associated Prioritization Objective Category, SARAs (described in the context of Stages 1 and 2) may be characterized by multiple factors, such as their ROSE score, how they contribute to Resilience Pillars, how they respond to planned and unplanned disturbance intensities, and which departure assessment metrics are associated with each SARA (where applicable). In some embodiments, the Resilience Pillars may be aggregations of desired landscape outcomes, such as Carbon Sequestration, Biodiversity, and Fire Adapted Community. The sections below describe how SARA characteristics not previously described are derived in further detail.

SARA Normalized Appraisal for ROSE Score

SARAs are assessed to determine their value in terms of importance to society. Because it is difficult to determine market values for one or more (e.g., all) SARA types (e.g., aspen stands, habitat areas, etc.), a framework may be used to determine relative value within the landscape. These potential socio-ecological values are calculated based on a number of SARA characteristics that are related to the SARA's importance to ecological systems and society, and in some cases, their context in terms of other important resources or communities. One or more (e.g., all) SARAs are assumed to be fully functioning when assessed through this process. Hence, values developed from this appraisal process are referred to as the ROSE score, and represent the maximum SARA value at each mapped location on the landscape. Base ROSE scores represent a value per unit area (e.g., square meter), while final mapped SARA ROSE scores refer to application of the base ROSE score to a geographic area to calculate the value across the SARA's spatial extent, in some cases including additional calibration of the ROSE score to account for geographic context in terms of dependent resources (including other SARA) and communities.

SARA Base ROSE Score Calculation

SARA base ROSE value scoring is implemented by applying a series of categorizations based on SARA-specific characteristics as well as general characteristics of spatial distribution, total area, or amount within the target region of analysis, and relative distance and concentration with respect to other SARAs that have interdependencies based on function and role in socioeconomic and ecological outcomes for the region. In particular, each SARA is manually evaluated and scored on the following global factors:
Discrete vs. assemblage: whether a SARA has a precise physical location and representation (discrete) or whether its represent a characteristic across a region (assemblage);
Regional uniqueness: whether, within the study area or regional ecosystem, a SARA is generally rare or common (e.g., abundant);
Global uniqueness: whether a SARA is generally rare or common (e.g., abundant) globally;
Years to replacement: if a SARA is damaged or lost (e.g., particularly due to wildfire), whether it takes a relatively short or long amount of time for it to recover or be restored;
Replacement cost: if a SARA is damaged or lost (e.g., particularly due to wildfire), whether the financial and/or resource cost for it to recover or be restored is relatively high or low; and/or
Public safety: whether a SARA contributes to supporting or improving public safety (e.g., in the context of a wildfire).

An assessment of these factors for each SARA in general for the overall study area generates a base SARA ROSE score that is uniform across one or more (e.g., all) occurrences of that particular SARA within the study area and applied at a consistent per-area scale (e.g., per m²). The base SARA ROSE score is a summation of scores assigned for each of these characteristics, with the greater values indicating more unique resources that are harder to/more expensive to replace. In some embodiments, values may be based on more direct and scarce benefits, as well as higher time and cost to replace or recover.

In some embodiments, each SARA may be first evaluated and scored on a set of the following global criteria and scoring, such as shown in Table 1 (below). The sum of each global criteria results in the total SARA base value.
Value: Is the feature a SARA? (Note that this step ensures that the minimum ROSE base score value of every SARA is 1.)
Uniqueness: Within the study area or regional ecosystem, is the SARA generally rare or abundant, common?
Public Safety: Does the SARA contribute to supporting or improving public safety, particularly in the context of a wildfire?
Replaceability Threshold: If a portion of the SARA is damaged or lost, particularly due to disturbance such as wildfire, would it be necessary to replace the entire SARA or restore/repair a portion of it in order to restore the SARA?
Years to Replacement: If the SARA is damaged or lost, particularly due to disturbance such as wildfire, does it take a relatively short or long amount of time for it to recover or be restored?
Replacement Cost: If the SARA is damaged or lost, particularly due to disturbance such as wildfire, is the financial and/or resource cost for it to recover or for it to be restored relatively high or low?

TABLE 1
SARA ROSE Global Criteria Scoring for Base Score

| | Scoring | Interpretation of scoring |
|---|---|---|
| Global Criteria | Range | range minimum/maximum |
| Value | 1 | 1 = Has been identified as a SARA |
| Uniqueness | 0-2 | 0 = not unique to the study area |
| | | or regional ecosystem (abundant/common) |
| | | 2 = rare |
| Public | 0-1 | 0 = not associated with public safety |
| Safety | | 1 = associated with public safety |
| Replaceability | 0-1 | 0 = replace a portion of the SARA when lost |
| Threshold | | 1 = when SARA is replaced the entire SARA |
| | | needs to be replaced |
| Years to | 0-2 | 0 = short timeframe |
| Replacement | | 2 = long timeframe |
| Replacement | 0-2 | 0 = low cost |
| Cost | | 2 = high cost |
| Base | 0-9 | 1 = minimum value |
| value | | 9 = high value |

Spatially-Varying SARA ROSE Scores

The base SARA ROSE score may be further adjusted before calculation of the SARA ROSE score by adjusting the SARA base ROSE score across the landscape. In some embodiments, a SARA tile may be a gridded representation of the SARA-mapped features, such that the SARA is divided up by a grid distributed across the landscape. These adjustments are made by assessing and quantifying other spatial characteristics associated with the SARA, such as how the location of the SARA relates to other important landscape characteristics including, but not limited to, area within watersheds, proximity to human population centers, SARA buffer defense zones, other dependent SARAs, a combination thereof, or the like. The relationship and calculation is unique to each SARA, reflecting distinct relationships between each SARA and other dependent and/or complementary SARAs. Below are non-limiting examples of methods for spatially-varying SARA ROSE scores. In some embodiments, a secondary step of spatially varying the base SARA ROSE score for some SARAs may not be conducted. The methods outlined below can be used singularly to vary the ROSE score, or a combination of methods can also be used to vary the ROSE score. The example methods for calculating these landscape dependency scores are provided below; other methods for calculating relative value of SARAs may be used without limitation. Each SARA's base score can be spatially varied and scored based on the criteria shown in Table 2.

TABLE 2
SARA ROSE Score Global Criteria Scoring for Spatially Varying the Base Score

| Added to which | Global Criteria | Scoring | |
|---|---|---|---|
| score points | (method) | Range | Interpretation |
| SARA footprint | Human Population | 0-2x SARA | SARAs that have human dependency |
| | Dependency (1) | base score | are more valuable in areas with |
| | | | higher population |
| SARA footprint | Dependencies/ | 0 to 2x (SARA | Higher values indicate |
| | Complementarities (2) | base score + | more dependent SARAs closer |
| | | watershed | to SARA being evaluated |
| | | uniqueness) | |
| Buffer | Defense | +10% of total value | Overlapping defense zones |
| | zone (3) | up to watershed | have greater value |
| | | uniqueness/overlap | |
| SARA footprint | Watershed | 0-1 | 1 = less frequent, |
| | uniqueness (4) | | 0 = occurs everywhere |
| | | | in watershed |

Landscape Dependency Score Calculation, Method 1: SARA with Dependent Human Populations ROSE Calculation

As discussed above, a SARA base ROSE score for each SARA tile (a defined geographic area of a SARA) at a per-area scale may be assigned. In some embodiments, a plurality of SARA tiles may be aggregated and associated with a treatment data map unit. In some embodiments, for some SARA, the size or share of the dependent human population it serves may be captured. In some cases, connections and services to human populations are transmitted via water resources (e.g., surface water). Here is an example calculation process for a surface water SARA:
1. Calculate a share of total human population for each hydrologic unit code 10-digit scale geographic area (HUC, e.g., HUC 10) in the project area and assign as a coefficient multiplier for each SARA tile of waterbodies such as rivers. The total human population may be based on, e.g., the most recent American Community Survey (ACS) census data from the U.S. Census Bureau at the block-group level within the watershed analysis area.
2. Increase the SARA tile value based on the total human population. In some embodiments, the system can multiply the SARA tile value by 1+% of total human population (e.g., ACS Census data) in the same HUC 10 area, increasing the SARA tile value by the percent of total human population within the SARA's HUC 10 region. In some embodiments, the SARA tile score may not be more than double based on this calculation.

The calculation process may also apply to other types of SARAs whose value may vary based on the surrounding population density. In some embodiments, the calculation process may comprise:
1. Calculate a share of total human population for a given spatial unit (e.g., hydrologic unit code 10-digit scale geographic area, abbreviated as HUC 10) in the project area and assign as a coefficient multiplier for each relevant, population-value relative SARA tile. The total human population may be based on, e.g., the most recent American Community Survey (ACS) census data from the U.S. Census Bureau at the block-group level within the analysis area.
2. Increase the SARA tile value based on the total human population. In some embodiments, the system can multiply the SARA tile value by 1+% of total human population (e.g., ACS Census data) in the same spatial unit, increasing the SARA tile value by the percent of total human population within the SARA's spatial unit. This formula allows for an increase in SARA tile up to double.

This is structured so that the SARA tile ROSE score cannot increase by more than 100%. For example, a surface water SARA base ROSE score may have a calculated value of 7 per square meter. Therefore, for a given surface water SARA tile of 100 m², its total SARA tile ROSE score would be calculated as 100*7=700. That SARA tile is in a HUC with 40% of all population in the landscape of interest. Resultantly, the total SARA tile ROSE score is calculated as 700*(1+0.4)=980, which per square meter is 980/100=9.8.

Landscape Dependency Score Calculation, Method 2: SARA with Other Dependent SARA ROSE Score Calculation

In other cases, the value of each incidence of a particular SARA can vary in value and importance based on the density and proximity of other SARA that depend upon it or are complementary to it. A couple examples of this would be:
Emergency service locations would benefit from having communication assets nearby
Recreation facility locations would benefit from having trails nearby
   It should be noted that the SARA base score is calculated on a per-SARA basis while this method varies the base score on a per-pixel (m2) basis within the SARA itself.

In some embodiments, for the calculation of this example communication transmission zone, in addition to assigning the SARA base score (option 1 discussed above), for each SARA tile at a per area scale, frequency and proximity of identified, dependent SARAs are used to vary the ROSE base score. For example, Fireshed boundaries at the “Project Area” level developed as part of the National Fireshed Registry are used in this analysis (similar to the use of HUC10 boundaries in the SARA with Dependent Human Populations Polygon Calculation described previously):
1. For each area of the focal SARA, identify other SARAs with dependencies on the focal SARA. Sum the area of one or more (e.g., all) of these identified dependent SARAs inside each Fireshed Project Area geographic zone.
2. Calculate and assign the percent of one or more (e.g., all) areas for dependent SARAs for each Fireshed Project Area geographic zone.
3. Multiply the SARA base ROSE score by 1+ percentage of one or more (e.g., all) dependent SARA areas in same Fireshed Project Area geographic zone. Effectively, this increases the SARA ROSE score by the percent of one or more (e.g., all) dependent SARAs within the same Fireshed Project Area geographic zone. In some embodiments, the SARA ROSE score may not be more than double based on this calculation.
4. As an example, the base SARA score for the Community Transmission Zone SARA is 4 per square meter. A Community Transmission Zone SARA tile of 100 m² has an initial SARA score of 100*4=400. That SARA tile is in a Fireshed Project Area that holds 10% of area of one or more (e.g., all) dependent SARAs (e.g., primary residential structures, emergency infrastructure) in Fireshed Project Area. So the SARA tile ROSE score becomes 400*(1+0.1)=440; the SARA tile ROSE score per square meter for that tile would be 4.4.
5. As an additional modification for some SARAs (e.g., Community Transmission Zones and/or Community Fuel Reduction Zone SARAs), the system can also vary the SARA base ROSE score with respect to the proximity of dependent SARAs. This is done by choosing a subset (e.g., two) of the dependent SARAs that are most important and most representative for a given focal SARA. Within a SARA tile's Fireshed Project Area, each dependent SARA (area-weighted) is identified, and its distance is measured. The focal SARA being scored then can have its value within a Fireshed Project Area adjusted within a range based on area-weighted distance of dependent SARAs.
   i. As an example, dependent SARA tiles within the Fireshed Project Area are measured in terms of size and distance. The value the dependent SARA tile contributes to the dependent SARA value weighting calculation is determined by dividing the area of that dependent SARA tile by the square root of the distance of that dependent SARA tile. Then this area-weighted value is normalized across one or more (e.g., all) dependent tiles, resulting in a value between 0 and 1. Then these area-weighted normalized values are used to vary the SARA tile ROSE score for the focal SARA tile within some range (e.g., plus or minus 10 percent).

In some embodiments, in addition to assigning the SARA base score (above) for each SARA, frequency and proximity of identified dependent and complementary SARA are used to vary the ROSE base score. Watershed boundaries at the “Project Area” level developed as part of the USGS Watershed Boundary Dataset (WBD) are used in this analysis:
1. For each area of the SARAs, identify other SARA with dependencies on the SARA and also identify other SARAs that are complementary to the SARA. Combine the boundaries of all of these identified dependent/complimentary SARAs inside each Watershed Project Area geographic zone.
2. Spatially vary and normalize the weights assigned to each SARA based on proximity to other dependent SARAs across each Watershed Project Area.
3. Multiply the SARA base ROSE score by 1+ normalized average distance of all combined dependent/complementary SARAs in the same watershed. Effectively, this increases the SARA ROSE base score by a factor of all dependent/complementary SARAs within the same watershed. By definition, it is impossible for a score to more than double based on this calculation.
4. For each SARA within a single watershed, interdependency/complementary values will range from 0-2× base score to identify the highest value SARAs within each watershed. When there are no interdependencies or complementary SARAs, the base score of the SARA is the final ROSE value.

Landscape Dependency Score Calculation, Method 3: SARA Buffer Defense Zones

A 100-foot buffer is applied to all SARAs which is considered a defensible space buffer. A buffer (defensible space) is more valuable when it protects multiple footprints of the SARA. This value may be greater than the SARA footprint itself, especially in the case of assets where the footprint (i.e. building) itself is not treated, but rather the area around the asset (i.e. the buffer) is treated to protect the SARA.

In areas where a SARA buffer overlaps with another buffer of the same SARA, the ROSE value in that pixel will be increased by a fraction of the SARA base score value (for example, 10%) for each overlap that occurs. This effectively allows for increased value in areas of higher concentration of that SARA, where a treatment would benefit multiple features of that SARA rather than just one. For example, if the SARA base score is 10, the overlapping areas are allowed to increase by 10% of the base score for each overlap, and a given pixel has 5 overlapping buffered SARAs present, then the SARA ROSE for that pixel would be 15. In areas where the SARA buffers do not overlap, the SARA buffer area will have a ROSE value equal to the SARA base value.

Landscape Dependency Score Calculation, Method 4: Watershed Uniqueness

An individual SARA will have greater value if it has a smaller footprint (total area) within a given watershed relative to the larger landscape. Effectively these areas represent watersheds that contain more “rare” or “unique” features of that SARA, relative to the context of the SARA across the rest of the landscape. In these watersheds where there is more “unique” occurrence of a given SARA, the value of the SARA is increased relative to its value within other watersheds. Watershed uniqueness is calculated based on the percent the SARA is represented within the given watershed. If a SARA only occurs in a small percentage of the watershed, it will have a higher value than a SARA that occurs in a large percentage of the watershed.
Watershed Uniqueness=1−(SARA area across the watershed/watershed area)
The calculated watershed uniqueness value is added to the base score value for all pixels that fall within the SARA footprint.

Although four different methods for calculating the landscape dependency score are discussed above in separate sections, the landscape dependency score may be calculated using any combinations of the methods.

SARA-Pillar Contributions

In addition to or instead of the Prioritization Objective categories, SARAs may also be grouped into a plurality of (e.g., 10) management goals. Building a framework that allows unique SARAs to be connected and grouped into the same set of objectives or management goals across landscapes minimizes application UI changes because the user is able to interact with the same set of data points regardless of location or scale of analysis. In some embodiments, the plurality of vegetation management goals can be based upon on the one or more SARA pillars (e.g., Pillars of Resilience). The one or more SARA pillars may provide a common language that bridges and packages disparate values into one framework where disturbance affects socio-ecologic value.

In a preferred embodiment, without limitation, the system can choose to use SARAs, rather than use the specific metrics, for one or more reasons:
SARAs provide flexibility to use data that managers are directly familiar with.
SARAs allowed managers to identify their important resources rather than rely on predefined metrics.
The SARA process is easily transferrable.

In order to translate SARAs as identified by project groups, individual SARA contributions may be assigned to pillars regardless of where the project occurs. The SARA-pillar contribution framework was tested and refined to identify variable contributions, and refine the differences between biological, anthropogenic, passive, and active. Within this framework, SARAs may contribute to one or many pillars; whereas SARAs may only be associated with a single Prioritization Objective Category, described previously.

In some embodiments, the SARA-pillar contribution may determine whether a SARA contributes to resilience (resilience pillars) of desired landscape outcome for the associated pillar based on values responsive to questions. In some embodiments, the SARA is operating in a functional state. Once one or more (e.g., all) values have been assigned to one or more (e.g., all) SARAs then the contribution is normalized relative to a total of 1 for input into the stewardship data map. The following questions and values (scores) (e.g., associated with each of the 10 Pillars of Resilience) are an example of a value framework calculated using a spreadsheet tool developed as part of this process. Other land planning processes could utilize an alternative framework within the context of the present disclosure without limitation.
Forest Resilience: Is this SARA associated with the persistence of forest vegetation (includes structure, composition, distribution, species diversity associated with ecosystem)? In some embodiments, three different scores are associated with the three answers. In some embodiments, a higher score indicates a higher contribution/association of the SARA to the resilience of desired landscape outcome.
   No
   Yes, the SARA is an anthropogenic resource (e.g., plantations)
   Yes, the SARA is an ecological resource
Fire Dynamics: Does this SARA contribute to how fire burns on the landscape (e.g., does the SARA influence severity, frequency, spread across the landscape)? In some embodiments, five different scores are associated with the five answers. In some embodiments, a higher score indicates a higher contribution/association of the SARA to the resilience of desired landscape outcome.
   No
   Yes, this SARA is discrete, and passively influences fire dynamics
   Yes, this SARA is discrete, and actively influences fire dynamics
   Yes, this SARA is an assemblage, and passively influences fire dynamics
   Yes, this SARA is an assemblage, and actively influence fire dynamics
Carbon Sequestration: Does this SARA influence carbon storage on the landscape? In some embodiments, four different scores are associated with the four answers. In some embodiments, a higher score indicates a higher contribution/association of the SARA to the resilience of desired landscape outcome.
   No or insignificant
   Yes, this SARA contributes to carbon storage in harvested wood products (e.g., plantations)
   Yes, this SARA contributes to longer-term carbon storage on the landscape
   Yes, this is a carbon specific SARA
Wetland Integrity: In some embodiments, three different scores are associated with the three answers. In some embodiments, a higher score indicates a higher contribution/association of the SARA to the resilience of desired landscape outcome.
   Is this SARA a meadow, riparian, or other wetland ecosystem?
   Is this SARA identified because of a species that is associated with a meadow, riparian, or other wetland system?
   No
Biodiversity Conservation Does this SARA contribute to biodiversity (e.g., individual species identified as SARA, individual ecosystems important for biodiversity)? In some embodiments, two different scores are associated with the two answers. In some embodiments, a higher score indicates a higher contribution/association of the SARA to the resilience of desired landscape outcome.
   No
   Yes
Water Security Does this SARA contribute to or monitor hydrologic dynamics on the landscape (e.g., does the SARA influence quality, quantity, or storage of water)? In some embodiments, five different scores are associated with the five answers. In some embodiments, a higher score indicates a higher contribution/association of the SARA to the resilience of desired landscape outcome.
   No
   Yes, SARA monitors hydrologic dynamics (e.g., water monitoring infrastructure)
   Yes, SARA influences hydrologic dynamics and is also identified as contributing to wetland integrity
   Yes, SARA is an anthropogenic asset that influences hydrologic dynamics (e.g., water infrastructure)
   Yes, SARA contributes to hydrologic dynamics, does not contribute to wetland integrity, and is not an anthropogenic asset
Air Quality Does this SARA contribute to air quality or greenhouse gases (GHG)? In some embodiments, four different scores are associated with the four answers. In some embodiments, a higher score indicates a higher contribution/association of the SARA to the resilience of desired landscape outcome.
   No
   Yes, this SARA actively contributes to the fire dynamics pillar (reduced fire emissions improves air quality)
   Yes, this SARA contributes to the carbon pillar (a reduction in GHG increases air quality)
   Yes, this SARA contributes to air quality, but does not contribute to fire dynamics or GHG
Fire-Adapted Communities: Is the SARA an anthropogenic asset? In some embodiments, three different scores are associated with the three answers. In some embodiments, a higher score indicates a higher contribution/association of the SARA to the resilience of desired landscape outcome.
   No
   Yes, discrete anthropogenic asset
   Yes, anthropogenic assemblage
Economic Diversity Does the SARA contribute directly to economic diversity (e.g., jobs are created as part of the SARA such as recreation, wood products, and infrastructure positions)? In some embodiments, two different scores are associated with the two answers. In some embodiments, a higher score indicates a higher contribution/association of the SARA to the resilience of desired landscape outcome.
   No
   Yes
Social and Cultural Well-Being Does this SARA provide a cultural or social connection to the landscape? In some embodiments, four different scores are associated with the four answers. In some embodiments, a higher score indicates a higher contribution/association of the SARA to the resilience of desired landscape outcome.
   No
   Yes, this SARA is an ecological SARA that people are connected to
   Yes, this SARA is a cultural resource
   Yes, this SARA provides direct connection the landscape through recreation opportunities

The output from this process are the fractional contributions of each SARA to each pillar. The contributions should sum to a total of 1. For example, for a single SARA such as Large Tree Groves, the SARA distribution of value (e.g., contribution) to the Pillars may be determined as: 0.08 for Social and Cultural Well-Being, 0.08 for Air Quality, 0.17 for Water Security, 0.17 for Biodiversity Conservation, 0.17 for Forest Resilience, 0.17 for Carbon Sequestration, and 0.17 for Fire Dynamics.

SARA Response Functions

Response functions are designed to help classify and quantify the effects of planned and unplanned disturbances on individual SARAs. Planned disturbances refer to vegetation management treatments, and unplanned disturbances refer to the hazards discussed in the context of Stage 2 (e.g., wildfire). Response functions can be developed from expert opinion and experience, or modeled to categorically quantify disturbance impacts. An example application of expert opinion-based categorical response functions follows below.

Once the normalized appraisal process determines each SARA's ROSE score, response functions may quantify the net value change (NVC), as a percentage, to a given SARA resulting from a disturbance at a given intensity. The change can be either beneficial (positive), detrimental (negative), or have no effect on a SARA's ROSE (0). The integration and use of the response functions in the risk and effects calculations are described in the context of Stage 4. In some embodiments, according to a response function, different ratings (e.g., −3, −2, 1, 0, 1, 2, 3) correspond to different percentages of change in value of ROSE (e.g., −100%, −66%, −33%, 0%, 33%, 66%, 100%).

Each intensity class of disturbance or treatment is tied directly to the disturbance or treatment itself, and are not directly related between disturbance types. For example, in some embodiments, different “fire intensity” classes (e.g., Fire Intensity Class 1, Fire Intensity Class 2, Fire Intensity Class 3, etc.) may be related to different conditional flame length heuristics (e.g., >2 feet, 2-4 feet, 4-6 feet, etc.) that are associated with different scorch heights, burn severities, fuel loads, etc. In some embodiments, different treatment intensities may be related to different treatment prescriptions that are associated with different machinery used, effects on woody and herbaceous vegetation, soil disturbance, etc. In some embodiments, a treatment prescription may be a potential treatment. This may include any type of management treatment, including post-fire restoration activities such as replanting.

Each SARA is evaluated for its response to each planned and unplanned disturbance type and intensity class. Below in Table 3 are several examples of SARA response functions for different disturbances and intensities.

TABLE 3
Examples of SARA Response Functions

| | Primary | Motorized & Non- | |
|---|---|---|---|
| Disturbance Types | Residential | Motorized Recreational | California Tiger |
| and Intensities | Structures | Trails | Salamander Habitat |
| Fire Intensity Class 1 | −1 | 0 | 1 |
| Fire Intensity Class 2 | −1 | 0 | 0 |
| Fire Intensity Class 3 | −2 | −1 | −1 |
| Fire Intensity Class 4 | −2 | −2 | −2 |
| Fire Intensity Class 5 | −3 | −3 | −3 |
| Fire Intensity Class 6 | −3 | −3 | −3 |
| Aerial/Tethered | 0 | 0 | −1 |
| Mechanized: Variable | | | |
| Density Thin w/large | | | |
| openings | | | |
| Hand Thinning: | 0 | 0 | 1 |
| Invasive species | | | |
| removal- | | | |
| Rearrangement: | 0 | 0 | −3 |
| Grapple/Machine | | | |
| Piling | | | |

In some embodiments, one or more of the following assumptions are made regarding the response functions:
The response functions assume that the SARA condition is in a generally functioning condition, and the associated percent loss is associated with the ROSE score of the SARA, not the actual current value of the SARA.
The response function resulting in a change in value cannot change the SARA's post-treatment or post-disturbance value outside of the range of 0 to the ROSE score (e.g., maximum value).
Assume that the response functions are associated with the net effect on the SARA over the course of the 10-year period. For example, a planned or unplanned disturbance may have immediate negative impacts, but net benefits over a 10-year period.
If fire is being applied as a planned disturbance, assume reasonable SARA specific mitigations will be in place during treatment; acceptable but negative effects should be accounted for as a response function only after some inevitable vegetation growth or recovery occurs.
Making vegetation (that a SARA is dependent on) more resilient to unnatural disturbances should be accounted for as a co-benefit in the response function. For example, for spotted owls, higher canopy covers are suitable for nesting and roosting. Treatments that retain much of the tree cover, but also make that cover more resilient to disturbance from that planned disturbance, will have a positive effect on spotted owl habitat.

Stage 4: Treatment ROI Optimization

The primary objectives for Stage 4 are to finalize a recommended treatment per treatment data map unit (described in the context of Stage 2) and package metrics associated with the socio-ecological effects of treatment, as well as economic cost. After the treatments and metrics are assigned to one or more (e.g., all) units, the treatment data map becomes the stewardship data map, which is a critical input dataset for analysis performed within the application. During Stage 4, the treatment ROI optimization wrapper script runs each potential likely treatment (per treatment data map unit) through the restoration calculation algorithm (another series of scripts), which performs a series of calculations to quantify the RROI of a treatment. The treatment ROI optimization algorithm then recommends the treatment that has the optimal benefit (e.g., maximum RROI, maximum RROI per treatment dollar, or other metrics), and packages treatment information along with RROI and other metrics for each treatment data map unit to create the stewardship data map. The inputs, treatment ROI optimization process, and restoration calculation algorithm are described in further detail below.

Stage 4 Inputs

The RROI algorithm, its components, and the final metrics generated to create the stewardship data map are based on a host of geospatial and relational databases containing information about landscape conditions such as, but not limited to, disturbances, treatments, departure metrics, post-fire conditions (when applicable), and SARAs described in the previous Stages 1-3. These inputs are shown in the workflow figures below for the treatment ROI optimization process and restoration calculation algorithm. Since the restoration calculation algorithm performs most of its calculations at the grid-cell level to capture the spatial variability in modeled disturbance probability and intensity and in SARAs spatial coverage and ROSE score, note that many of the inputs described are ingested to the RROI algorithm in raster format.
Current vegetation percent departure (geospatial raster dataset): represents the mapped distribution of the extent of departure of the landscape from historical or ecologically-functional conditions (described previously in the context of Stage 2). In some embodiments, a vegetation departure intensity related to a database table of fractional value reduction factors may be applied. The fractional value reduction factors may be constant across the SARAs that they are applied to. Application is described further in the restoration calculation algorithm description.
Disturbances:
   Disturbance probability (geospatial raster dataset): represents the mapped distribution of the probability of disturbance (planned or unplanned). In other words, the disturbance probability raster layer shows where the disturbance is likely to occur, and the magnitude of that likelihood. The input disturbance probabilities should be the probability over a 10-year period (if annualized, converted to 10-year prior to ingestion to the algorithm) (described previously in the context of Stage 2).
   Current disturbance intensity (geospatial raster dataset): represents the mapped distribution of the intensity of disturbance (planned or unplanned). In other words, the disturbance intensity raster layer shows the magnitude of intensity of the disturbance, and where varying intensities occur. As one non-limiting example, for wildfire, this raster dataset shows the magnitude of flame lengths occurring in any given location on the landscape (described previously in the context of Stage 2).
Treatments:
   Treatment Data Map Unit Treatments (vector): represents the mapped distribution of treatments by treatment data map unit. Each treatment data map unit has its own recommended set of potential treatments based on biophysical characteristics of the unit, and the probability of each treatment. The assignment of these treatments and probabilities was described previously in the context of Stage 2.
      Treatment probabilities (geospatial raster dataset): represents the mapped distribution of the probability of planned disturbance (e.g., treatment). In other words, the treatment probability raster layer shows where treatments are likely to occur, and the magnitude of that likelihood. Probability values represent the probability of treatment over a 10-year period. The probabilities are based upon the type of treatment (e.g., treatment intensity) recommended at that location, and are uniform across a single treatment data map unit (described previously in the context of Stage 2). Data is converted from vector to raster format for application in the restoration calculation algorithm.
      Treatment intensities (geospatial raster dataset): represent the mapped distribution of the type of planned disturbance (e.g., treatment intensity). In other words, the treatment intensity raster layer shows where treatments are likely to occur and the type of treatment assigned for each location on the landscape. In some embodiments, the treatment may be uniform across a single treatment data map unit (described previously in the context of Stage 2). Data is converted from vector to raster format for application in the restoration calculation algorithm.
   Treatment disturbance reduction (database): a relational database describing how the intensities of disturbances are reduced by treatments (described previously in Stage 2).
   Other landscape spatial datasets related to treatment impacts (geospatial raster dataset): the algorithm may ingest any number of other spatial datasets that help inform treatment impact/efficacy. For example, for post-fire restoration treatments, a seed regeneration probability spatial dataset may be ingested to the algorithm to help highlight areas where post-fire restoration treatments may be needed due to lower natural regeneration.
SARAs:
   SARA Prioritization Objective Category: flag denoting which Prioritization Objective Category the SARA is associated with (i.e. Assets, Biodiversity, Carbon, Ecological Commodity, History & Knowledge, Recreation, Safety, or Water).
   SARA ROSE (geospatial raster dataset): represents the mapped distribution of the ROSE score of each SARA. In some embodiments, because the SARA ROSE scores are mapped datasets, they also show the footprint of each SARA (described previously in Stage 3).
   SARA disturbance response function (database): is a relational database describing how the SARA responds to each unplanned disturbance intensity that allows for translation of disturbance intensity to a percent value change of the SARA (described previously in Stage 3).
   SARA treatment response function (database): is a relational database describing how the SARA responds to each unplanned disturbance intensity that allows for translation of treatment to a percent value change of the SARA (described previously in Stage 3). Also included is a flag denoting the maximum benefit a post-fire restoration treatment can have, dependent on the SARA and burn severity.
   SARA departure metric (where applicable): flag denoting the departure metric (described previously) that should be used to estimate the current functional value of the SARA.
   SARA-Pillar Contributions (database): is a database describing how each SARA's metrics (e.g., RROI, risk, treatment effects, change in disturbance effects) should be distributed amongst the resilience pillars (described previously in Stage 3).

Treatment ROI Optimization

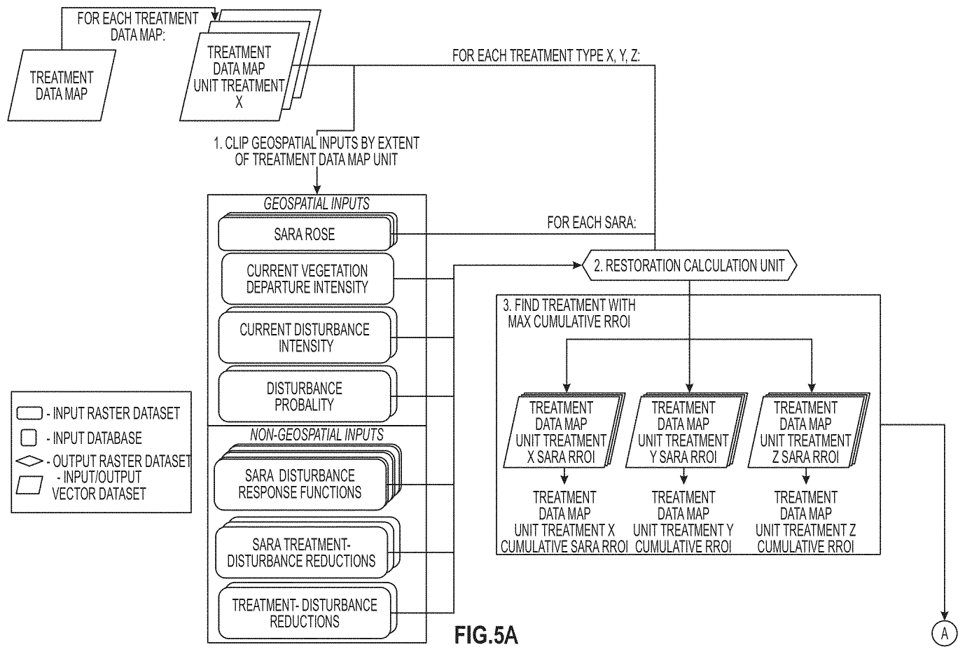

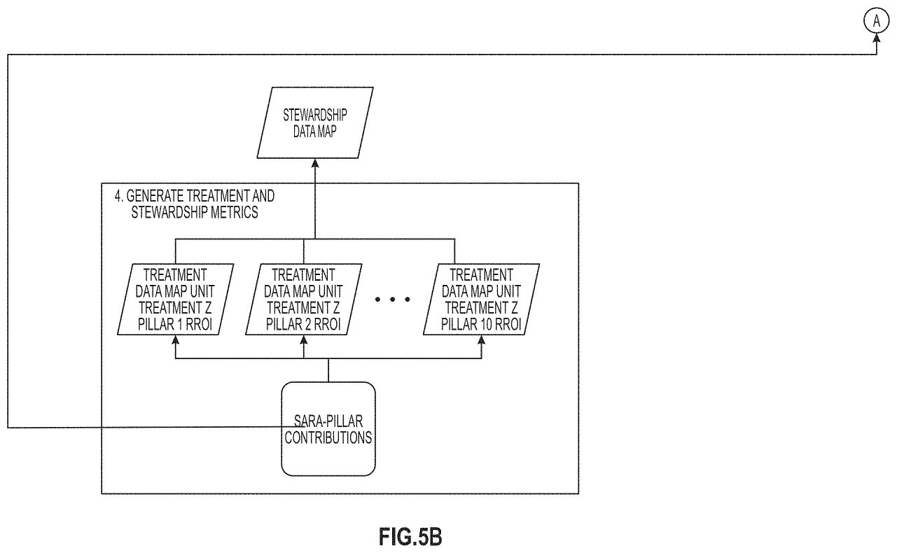

The general workflow for the treatment ROI optimization process is shown in FIGS. 5A and 5B. The purpose of the treatment ROI optimization is to select a single recommended treatment from a plurality of potential treatments based on the optimal RROI for the SARAs located within the unit. In some embodiments, the selection may be based on the potential treatment that generates the highest cumulative RROI for one or more (e.g., all) SARAs within each treatment data map unit. In some embodiments, the entire treatment ROI optimization process iterates over each treatment data map unit until the process has been completed for all treatment data map units. As described previously in the context of Stage 2, the treatment data map is comprised of treatment data map units that segment the landscape into individual components. Each one of these treatment data map units is assigned combinations of potential initial and follow-up treatments (herein, referred to as potential treatments) that could be performed in that location.

The selected recommended treatment may be used by, e.g., a land owner or developer, to assess which treatment is optimal for achieving a given goal such as staying within a monetary budget, attracting more tourists, reducing monthly utility costs, reducing carbon dioxide, etc. In some embodiments, the system may present different optimal treatments for different goals. The benefit to this approach is that the system presents the users with one or more recommended treatments that the user may select from depending on the specific goal. The user may provide one or more priorities for different goals/objectives. In some embodiments, the system may provide the user with one or more visualizations of the advantages, disadvantages, and/or tradeoffs for the different recommended treatments. For example, a first recommended treatment may involve treating a field with fire, and a second recommended treatment may involve grazing. The system may select the fire treatment when the user's objectives are to control invasive species and improved soil quality, but may select the grazing treatment when the user's objectives are to reduce fuel loads on an annual basis. In some embodiments, the system may use the priorities to select an overall recommended treatment amongst the plurality of recommended treatments. In some embodiments, the system may also store information regarding the plurality of recommended treatments, including those other than the overall recommended treatment. In this manner, the user may be able to explore other recommended treatment options should the user's goal change for a given land.

FIGS. 5A and 5B depict an example automated process for ROI optimization, in accordance with some embodiments. First, for a given treatment data map unit, one or more (e.g., all) geospatial inputs (described above) are clipped to the same (spatial) extent as the treatment data map unit. This includes the ROSE rasters for one or more (e.g., all) SARAs within the treatment data map unit, the current vegetation departure intensity raster, and the intensity and probability rasters for each disturbance included in the assessment.

Second, the restoration calculation algorithm (described further below) is run iteratively for each potential treatment (e.g., Treatment X, Y, Z), and then for each SARA, using the clipped geospatial inputs and a host of database inputs. The calculations in the restoration calculation algorithm are described in further detail in the section below. The output from the restoration calculation algorithm is the RROI for each potential treatments X, Y, Z and for each SARA A, B, C. For example, for a given treatment data map unit with 3 different SARAs and 3 potential treatment options, the SARA RROIs associated with Treatment X could be calculated as 4, −2, and −0.5, whereas the SARA RROIs associated with Treatment Y could be calculated as 5, −2, and −, and the SARA RROIs associated with Treatment Z could be calculated as 4, 2, −0.5 (for SARAs A, B, and C, respectively).

Third, the treatment SARA RROIs are summed to calculate the potential treatment cumulative RROI. These cumulative RROIs are then compared to select the potential treatment with the maximum RROI as the recommended treatment. In some embodiments, one or more (e.g., all) cumulative RROIs may be negative, and the treatment selected may have the least negative RROI. Negative RROI is described further in the restoration calculation algorithm section below. For the same treatment data map unit described above, the cumulative RROI for Treatment X would be 1.5 (4−2−0.5), the cumulative RROI for Treatment Y would be 2 (5−2−1), and the cumulative RROI for Treatment Z would be 5.5 (4+2−0.5), and in this example, Treatment Z would be selected. Additionally, note that the treatment could be selected based upon both RROI and treatment cost, or other combinations of treatment impact metrics.

Fourth, treatment and stewardship metrics and characteristics are calculated for the given treatment data map unit including but not limited to, treatment (initial and follow-up treatments recommended from the previous step), treatment costs, and total product removal (e.g., the amount of wood that can be harvested from the treatment within that particular unit). Stewardship metrics include but are not limited to: RROI, current value, current risk, treatment effects, and change in disturbance effects (all described in the restoration calculation unit section below). Stewardship metrics are represented at the treatment objective level (described in Stage 1), rather than the individual SARAs. The stewardship metrics for the treatment objectives are simply aggregated (i.e. summed) for the SARAs related to each objective. Each SARA may only be associated with one treatment objective category. Some metrics may be calculated at the level of the 10 Resilience Pillars (described in Stage 3); SARAs may contribute to several different pillars, and therefore, metrics associated with the optimal treatment are calculated for each pillar by:

X_{Pillar}=ΣX_{SARA}×P_{SARA,Pillar},

where X_{Pillar} is the pillar stewardship metric (e.g., total pillar RROI), X_{SARA} is the stewardship metric value of a SARA (e.g., total SARA RROI), and P_{SARA,Pillar} is a SARA-Pillar contribution (value less than or equal to 1). In some embodiments, each pillar's stewardship metrics are comprised of at least one or more SARAs. As described in the context of Stage 3, the resilience pillars are a way to standardize SARAs and treatment objectives across different landscapes and ecotypes. In some embodiments, recommendations for SARAs to be considered in treatment mitigations are also included for the given treatment data map unit.

In some embodiments, one or more (e.g., all) values for one or more (e.g., all) treatment data map units are joined back to the treatment data map. The result of the Treatment ROI Optimization process is the stewardship data map, which is simply the treatment data map populated with specific information about treatment and stewardship metrics for each treatment data map unit.

Restoration Calculation Algorithm

A factor driving fuel treatment planning efforts is the reduced risk associated with disturbances such as wildfire. The fuel treatment planning frameworks may be driven by hazard, rather than by the potential to change the hazard through vegetation fuel treatments. Further, the fuel treatment planning frameworks may not assess the impacts of proposed treatments on (1) the change in risk associated with disturbance(s) and/or (2) the functional value of the landscape itself, regardless of disturbance(s). For example, in an area suitable for a variable density thinning treatment, a fuel treatment planning framework may not estimate how such candidate treatment affects the change in risk of wildfire or provide a functional value of the landscape after such treatment.

Landscape Value Beyond Loss Avoidance

Although risk may be a piece of information that helps inform decision-makers about areas that are in need of treatment in order to avoid or reduce loss, assessing treatment and disturbance effects helps provide decision-makers with information about the where, when, why, and how of vegetation management plans so they can better understand the true return on an investment from performing treatments instead of just what a landscape has to lose if nothing is done.

Embodiments of the present disclosure include a framework for quantifying planned and unplanned effects and deriving landscape-scale information about RROI from performing vegetation management treatments. In some embodiments, a risk-and-opportunity-based framework using econometrics, informed from the normalized socio-ecological appraisal process, is provided. This framework is referred to as the “restoration calculation algorithm.” The framework includes a stepwise combination of fuzzy and probabilistic-logic workflows that relates and guides a host of geospatial and database inputs through a series of calculations to estimate pre- and post-treatment and/or disturbance states of landscape components.

The final output from the restoration calculation algorithm are spatially-distributed RROI values. An RROI value may be the composite of (1) the probabilistic effect that treatments have on value, regardless of disturbances (e.g., “Treatment Effects”); and (2) the probabilistic change in the effects of unplanned disturbance(s) on value (e.g., change in risk or change in disturbance effects). This quantity can be interpreted as the expected return on investment over, e.g., a 10 year planning horizon for the selected treatment. Effects may be computed as a function of socio-ecological value, which provides a valuation abstraction enabling comparison of treatment effects on disparate landscape elements (e.g., homes versus large tree groves). These disparate elements have measurable qualities that would be difficult, if not impossible, to compare within individual (and more typical) frames of reference. Embodiments of the disclosure may expand the evaluation of “effects” quantified to the impacts of only unplanned disturbances, only planned disturbances (e.g., treatments), or both.

In some embodiments, the system assesses the effects of recommended treatments on SARA scores, irrespective of disturbance(s). The treatment effects incorporate information about the type and intensity of the recommended treatment, the probability of that treatment, and how SARAs respond to the treatment. In some embodiments, within the restoration calculation algorithm, positive treatment effects can only occur in areas that would benefit from treatment, which may prevent or reduce the number of treatments being driven to areas unnecessarily. The restoration calculation algorithm can also highlight areas that have a net adverse impact from treatments, which may redirect treatment actions to more appropriate areas as well.

The intensity of unplanned disturbances such as wildfire or drought-driven vegetation mortality can also be altered depending on vegetation treatments. The disclosed workflow may comprise an assessment of the change in potential disturbance intensity associated with recommended treatments, and an evaluation of how that change in intensity impacts SARAs.

SARA areas with the highest RROI value indicate locations where treatments would either improve the value, reduce risk, or both. For example, a mature, fire-suppressed forest could have its function improved from a mechanical variable-density thinning treatment, while that same treatment can also avoid some loss from unplanned disturbance (e.g., wildfire), thus equating to positive RROI value. Conversely, SARA areas with negative RROI values would indicate locations where treatments would either negatively impact value, adversely impact the positive effects of wildfire specific to that SARA, or both. For instance, a decadent chaparral patch, shown to be within its natural range of variability, could have a negative treatment effect from mastication, while a high intensity unplanned fire would actually benefit that particular SARA. In other words, an investment in treatments in this location for this SARA would actually create a net loss in socio-ecologic value and may be prioritized for treatment over another area where there is a calculated socio-ecologic value gain without some clear tactical rationale to override the restoration calculation algorithm's unbiased, data-driven results.

This quantification of effects (positive or negative) from planned and unplanned disturbances incorporates the tradeoffs of spatially explicit action or inaction early in the planning process. It additionally facilitates a sound strategic plan that bridges environmental analysis requirements with the realities of designing a strategic treatment matrix, which will ultimately reduce internal and stakeholder conflict throughout the planning process and into environmental analysis comment and review periods.

General Post-Disturbance Value Calculation

An important calculation used throughout the restoration calculation algorithm is the calculation of post-disturbance (planned or unplanned) value. This calculation is used to compute SARA scores post-treatment, post-disturbance (no treatment), and post-treatment and post-disturbance. An example calculation is as follows (variations might include clipping values, non-linear ROSE weightings, etc.):

ν_{SARA,t+1}=ν_{SARA,t}+(ROSE_{SARA}×NVC_{SARA,d}/100), EQN 1:

where ν_{SARA, t+1} is the post-disturbance (planned or unplanned) value, ν_{SARA,t} is the pre-disturbance (planned or unplanned) (REASE) score, ROSE_{SARA} is the ROSE score of the SARA, and NVC_{SARA,d} is the SARA's NVC response to the disturbance (planned or unplanned) represented as a percent NVC. The post-disturbance (planned or unplanned) value ν_{SARA,t+1} is limited to values ranging from 0 to ROSE_{SARA} (e.g., 0 is the minimum allowable value and ROSE_{SARA} is the maximum allowable value).

General Workflow Steps

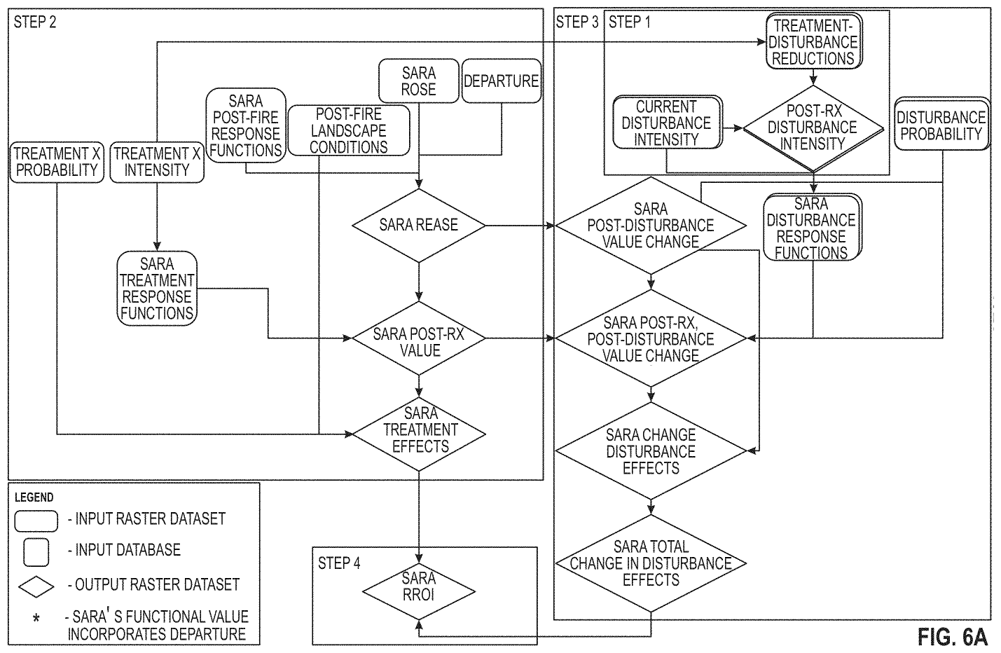

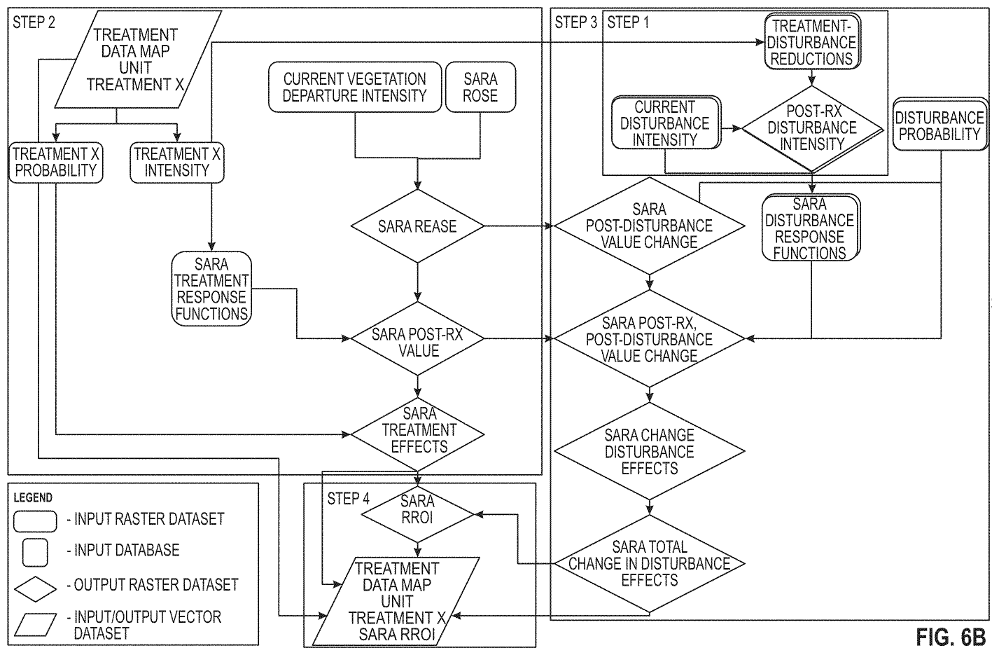

The general workflow of the restoration calculation algorithm is depicted FIG. 6A. The SARA RROI value is calculated based on the clipped geospatial inputs from the treatment ROI optimization process, as well as several relational databases. One or more (e.g., all) calculations occur on a raster grid-cell basis; therefore, prior to running the restoration calculation algorithm, one or more (e.g., all) input rasters must be in the same projected coordinate system using the same grid-cell size. FIGS. 6A and 6B depict example processes for the restoration calculation, in accordance with some embodiments.

Referring to FIG. 6A, step 1: Firstly, post-treatment disturbance intensity rasters are created through an iterative process. Planned disturbance (e.g., treatments) influence the way future unplanned disturbance occurs on the landscape. For example, if a fire is predicted to burn at high severity on the landscape prior to treatment, a treatment may reduce the unplanned disturbance to a moderate severity. In order to evaluate the impact of treatment, disturbance reduction responses may quantify how planned disturbance can influence future unplanned disturbance.

Each disturbance intensity raster is evaluated separately. First, the treatment intensity raster is converted to a treatment disturbance reduction raster using the Treatment Disturbance Reduction lookup database. This reduction is then applied to the current disturbance intensity raster to generate the post-treatment disturbance intensity raster, such that:

I_{gridcell x,post-rx}=I_{gridcell,current}−t,

where I_{gridcell x, post-rx} is the post-treatment disturbance intensity at a particular raster gridcell, I_{gridcell, current} is the current disturbance intensity at a particular raster gridcell, and t is the treatment-disturbance reduction. For example, if Treatment X is associated with a treatment-disturbance reduction of 2 for Disturbance Y, and the current disturbance intensity raster value is 5 at a particular gridcell, the post-treatment disturbance intensity raster would be 3. Because the treatment is uniform within each treatment data map unit assessed within the restoration calculation algorithm, the same treatment-disturbance reduction is applied to each gridcell within the clipped current disturbance intensity raster. In some embodiments, the treatment-disturbance reduction may vary between disturbance types. The maximum reduction of treatment on disturbance intensity may be limited to some minimum value, such that treatment can only reduce but not remove the intensity of disturbance.

Step 2: Secondly, the effects of treatment on the ecological function of the SARA are evaluated to generate a value called SARA Treatment Effects. The second step of the restoration calculation algorithm involves many sub steps, which are as follows:
a. Calculate the SARA relative actual socio-ecological value (e.g., current value)

The ROSE score is not necessarily the SARA's current value. Therefore, current condition is considered to identify the relative actual socio-ecological value (REASE).

For most anthropogenic SARAs, the current SARA value is equivalent to the ROSE score. A primary home, for example, may have structural deficiencies that would keep its potential value from being realized, but only a site-specific inspection could allow for that assessment and vegetation treatments cannot change the function of a home by addressing its structural deficiencies.

Conversely, the current value of an ecologic SARA like a mature, fire-suppressed large tree grove can be approximated remotely by assessing the departure of its current vegetation structure from its modeled natural range of variability. If vegetation is highly departed from its natural range of variability, the SARA ROSE score is reduced. Additionally, if the landscape experienced wildfire, the current value of the SARA may have been impacted by the severity of fire in a given location.

This step involves calculation of the SARA REASE score, which represents the current value of the SARA. First, the current vegetation departure intensity raster is related to a fractional value reduction factor for each grid-cell. Then, the ROSE score of the SARA is adjusted to the REASE value, such that:

REASE_{SARA}=(1−dep/100)×ROSE_{SARA},

where REASE_{SARA} is the SARA REASE score (current value), dep is the percent departure (dependent on the departure metric identified for the SARA, where applicable), and ROSE_{SARA} is the SARA ROSE score. If no departure metric was identified for the SARA, then the REASE_{SARA} is set equal to the ROSE_{SARA}. For example, for a given grid-cell of SARA where the current vegetation departure metric is 10%, an ecological SARA ROSE score of 10 would be calculated as a SARA REASE value of 9. Alternatively, for an anthropogenic SARA with no departure metric, a ROSE score of 10 would not be reduced and the SARA REASE value would also be 10.

In scenarios where the landscape being evaluated has recently burned in a wildfire, the REASE may be further updated to reflect the post-fire SARA condition. In this case, the SARA REASE would be updated using EQN 1, applied as:

REASE_{SARA}=REASE_{SARApre-fire}+(ROSE_{SARA}λNVC_{SARA,d}/100)

where REASE_{SARA} is the SARA Relative Actual Socio-Ecological value SARA value updated for post-fire conditions, REASE_{SARA}, pre-fire is the SARA REASE value pre-fire, ROSE_{SARA} is the Relative Potential Socio-Ecological value of the SARA, and NVC_{SARA,d} is the based on the SARA's response to the classified post-fire landscape condition (for example, burn severity, basal area loss) represented as a percent net value change. The percent net value change is derived based on the post-fire landscape condition intensity class and SARA Disturbance Response Functions. For example, if the SARA REASE pre-fire value is 9, the ROSE SARA value is 10, and the landscape had burned at moderate severity, which is equated to an NVC of −66% for a particular gridcell for the SARA of interest, then the SARA REASE would be 2.4; as described previously, the minimum and maximum allowable values of each SARA are 0 and its ROSE value, respectively.
a. Calculate the SARA post-treatment value
   The calculation of the SARA post-treatment value raster uses the relationship described previously. First, the treatment intensity raster is converted to SARA response function ratings using the SARA treatment response functions. Then, the response function ratings are converted to NVC values per the table described in Stage 3 (e.g., −3 equates to an NVC of −99%, −2 equates to an NVC of −66%, etc.). Then, the relationship is applied as:

ν_{SARA,t+1}=ν_{SARA,t}+(ROSE_{SARA}×NVC_{SARA,d}/100)
where ν_{SARA, t+1} is the post-treatment SARA value, ν_{SARA, t} is the SARA REASE value, ROSE_{SARA} is the ROSE score of the SARA, and NVC_{SARA,d} is the SARA's response to the treatment represented as a percent net value change. For example, if the SARA REASE value is 8, the ROSE SARA value is 10, and the treatment is equated to an NVC of 33% for a particular gridcell for the SARA of interest, then ν_{SARA, t+1} would be 11.3; as described previously, because the maximum allowable value of each SARA is its ROSE score, v_{SARA, t+1} would then be capped to a value of 10.
b. Calculate the SARA treatment effects
   The SARA treatment effects (TE) score is the probabilistic SARA score change associated with treatment, calculated as:

Δν_{SARA}=(ν_{SARA,t+1}−ν_{SARA,t})×p,

where Δν_{SARA} is the SARA TE score, ν_{SARA,t+1} is the post-treatment SARA score, ν_{SARA,t} is the SARA REASE score, and p_{SARA} is the treatment probability. For example, if the post-treatment SARA score is 10, the SARA REASE score is 8, and the 10-year treatment probability is 0.1 (e.g., 10% probability), the SARA TE score would be 0.2. A negative SARA TE score indicates that the treatment had a negative impact on the SARA, whereas a positive SARA TE score indicates that the treatment had a positive impact on the SARA.
In scenarios where the landscape being evaluated has recently burned in a wildfire, there are two components of the above calculation that may vary based on post-fire landscape conditions: the response of the SARA to treatment and the magnitude of SARA TE. Firstly, if the treatment being evaluated has benefit to the SARA (i.e. response ratings greater than 0) but the magnitude of the SARA response to post-fire landscape condition (e.g. burn severity) is maximal or moderate loss (for example, a response rating of −3 or −2 to the burn severity class), the treatment response rating would be either reduced to 0 or reduced by a factor (e.g., reduced by a factor of 1), respectively. This adjustment of the SARA response rating to the treatment is to account for situations in which the fire had done so much damage that treatment of that SARA is no longer relevant within the 10-year timeframe; for example, for a large tree grove SARA, if the fire resulted in 100% loss, then there is nothing that could be done within the 10-year computation window to improve that SARA. Secondly, the TE of post-fire revegetation treatments may be adjusted based upon the probability of natural regeneration, when data are available. In these cases, a TE scaling factor may be calculated as:

tsf=1−p_{regen}

where tsf is the treatment scaling factor and p_{regen} is the probability of natural regeneration (fractional value between 0-1). The tsf is then applied to the SARA TE (Δν_{SARA}) to update its value, as:

Δν_{SARA}=tsf×Δν_{SARA,max},
where Δν_{SARA} is the adjusted SARA TE value and Δν_{SARA,max} is the unadjusted SARA TE value. Effectively, where natural regeneration probability is high, this will reduce the SARA TE value in these areas to effectively drive greater SARA TE to areas where natural regeneration probability is low and a revegetation treatment would be most impactful.

Step 3: Thirdly, the effects of treatment on disturbances are evaluated to generate a value called SARA Change in Disturbance Effects. This step effectively evaluates whether the treatment results in avoided loss for a SARA, or if the treatment instead negatively impacts the beneficial impacts of the disturbance intensity at a given location. The third step of the restoration calculation algorithm involves several sub steps, which are as follows:
a. Calculate the SARA post-disturbance value change (no treatment) (for each disturbance) To calculate the SARA post-disturbance (e.g., wildfire) value change in the absence of treatment, the SARA post-disturbance values must be calculated iteratively for each disturbance and then compared to the pre-disturbance value (in this case, the SARA REASE). For each disturbance, the current disturbance intensity raster is converted to SARA response function ratings using the SARA Disturbance Response Functions. Then, the response function ratings are converted to NVC values per the table described in Stage 3 (e.g., −3 equates to an NVC of −99%, −2 equates to an NVC of −66%, etc.). Then, for each disturbance, the post-disturbance SARA value (no treatment) is calculated as:

ν_{SARA,t+1}=ν_{SARA,t}+(ROSE_{SARA}×NVC_{SARA,d}/100)
where ν_{SARA, t+1} is the post-disturbance SARA value, ν_{SARA, t} is the SARA REASE value, ROSE_{SARA} is the ROSE value of the SARA, and NVC_{SARA,d} is the SARA's response to the disturbance represented as a percent net value change. For example, if the SARA REASE value is 8, the ROSE SARA value is 10, and a given disturbance is equated to an NVC of −99% for a particular gridcell for the SARA of interest, then ν_{SARA, t+1} would be −1.9; as described previously, because the minimum allowable value of each SARA is 0, ν_{SARA, t+1} would then be set to a value of 0.
   After each SARA post-disturbance value is calculated, the SARA post-disturbance value change (again, in the absence of treatment) is evaluated iteratively for each disturbance, calculated as:

Δν_{SARA,disturbance}=(ν_{SARA,disturbance,t+1}−ν_{SARA,t})×p_{disturbance},
where Δν_{SARA,disturbance} is the SARA post-disturbance value change, ν_{SARA,disturbance,t+1} is the post-disturbance SARA value, ν_{SARA,t} is the SARA REASE, and p_{disturbance} is the 10-year disturbance probability. In some embodiments, the disturbance probabilities may be annualized but the restoration calculation algorithm is calculated over a 10-year basis (and treatment probabilities are over a 10-year period), so the disturbance probability is multiplied by 10. For example, if the post-disturbance SARA value is 0, the SARA REASE value is 8, and the disturbance probability is 0.1 (e.g., 10% probability), the SARA post-disturbance value change would be −0.8. A negative value indicates value loss from the disturbance intensity, whereas a positive value indicates value gain from the disturbance intensity.
b. Calculate the SARA post-treatment, post-disturbance value change (for each disturbance) The post-treatment, post-disturbance value change is calculated similarly as the post-disturbance (no treatment) value change calculated in the previous step, except with different inputs. For each disturbance, the post-treatment disturbance intensity raster is converted to SARA response function ratings using the SARA Disturbance Response Functions. Then, the response function ratings are converted to NVC values per the table described in Stage 3 (e.g., −3 equates to an NVC of −99%, −2 equates to an NVC of −66%, etc.). Then, for each disturbance, the post-treatment, post-disturbance SARA value is calculated as:

ν_{SARA,t+1}=ν_{SARA,t}+(ROSE_{SARA}×NVC_{SARA,d}/100)
where ν_{SARA, t+1} is the post-treatment, post-disturbance SARA value, ν_{SARA, t} is the SARA post-treatment value (calculated in Step 2), ROSE_{SARA} is the ROSE score of the SARA, and NVC_{SARA,d} is the SARA's response to the disturbance represented as a percent net value change. For example, if the SARA post-treatment value is 10, the ROSE SARA value is 10, and a given post-treatment disturbance is equated to an NVC of −33% for a particular gridcell for the SARA of interest, then v_{SARA, t+1} would be 6.7.
After each SARA post-treatment, post-disturbance value is calculated, the SARA post-treatment, post-disturbance value change is evaluated iteratively for each disturbance, calculated as:

Δν_{SARA,disturbance}=(ν_{SARA,disturbance,t+1}−ν_{SARA,t})×p_{disturbance},
where ν_{SARA,disturbance} is the SARA post-treatment, post-disturbance value change, ν_{SARA,disturbance,t+1} is the post-treatment, post-disturbance SARA value, ν_{SARA,t} is the post-treatment value, and p_{disturbance} is the disturbance probability. In some embodiments, the disturbance probabilities may be annualized but the restoration calculation algorithm is calculated over a 10-year basis (and treatment probabilities are over a 10-year period), so the disturbance probability is multiplied by 10. For example, if the post-treatment, post-disturbance SARA value is 6.7, the SARA post-treatment value is 10, and the disturbance probability is 0.1 (e.g., 10% probability), the SARA post-disturbance value change would be −0.33. A negative value indicates value loss from the disturbance intensity, whereas a positive value indicates value gain from the disturbance intensity.
c. Calculate the SARA Change in Disturbance Effects (for each disturbance)
   The SARA change in disturbance effects for each disturbance is calculated as the probabilistic difference between the post-disturbance SARA value change, with and without treatment. Because treatment only affects the disturbance intensity values within this framework and not the disturbance probabilities, the probability of disturbance is applied at this step. The SARA change in disturbance effects is calculated iteratively for each disturbance, such that:

ΔDE_{SARA,disturbance}=Δν_{SARA,disturbance,treatment}−Δν_{SARA,disturbance,no treatment}
where ΔDE_{SARA,disturbance} is the change in SARA disturbance effects for a particular disturbance, Δν_{SARA,disturbance,treatment} is the SARA post-treatment, post-disturbance value change, and Δν_{SARA,disturbance,no treatment} is the SARA post-disturbance value change (no treatment). For example, if the SARA post-treatment, post-disturbance value change is −0.33 and the SARA post-disturbance (no treatment) value change is −0.8, the change in SARA disturbance effects would be 0.47. A positive value indicates that the treatment resulted in avoided loss from the disturbance for the SARA, whereas a negative value indicates that the treatment reduced the positive benefits of disturbance for the SARA.
d. Calculate the SARA Change in Disturbance Effects (across one or more (e.g., all) disturbance types)
   Finally, the total SARA Change in Disturbance Effects (ΔDE_{SARA}) is calculated as:

ΔDE_{SARA}=ΣΔDE_{SARA,disturbance}
such that one or more (e.g., all) of the calculated change in disturbance effects are summed for one or more (e.g., all) disturbances. For example, for a given gridcell, if there are two disturbances (wildfire and drought-induced beetle mortality), and the resulting change in disturbance effects for a SARA was 0.47 and 0.11, respectively, the total SARA Change in Disturbance Effects would be 0.58.

Step 4. The fourth step in the restoration calculation algorithm is to calculate the RROI, such that:

RROI_{SARA}=TE_{SARA}+ΔDE_{SARA},

where RROI_{SARA} is the SARA RROI, TE_{SARA} is the SARA Treatment Effects, and ΔDE_{SARA} is the total SARA Change in Disturbance Effects. For example, if TE_{SARA} is 0.2 and ΔDE_{SARA} is 0.58, the RROI_{SARA} would be 0.78. A positive value indicates net benefit from treatment, whereas a negative value indicates a net negative impact of treatment. Within each treatment data map unit, the RROI (calculated on a per-gridcell basis) is variable due to the variable nature of several of the restoration calculation algorithm inputs (e.g., disturbance intensity, disturbance probability, current vegetation departure). To calculate the SARA RROI for the treatment data map unit, the RROI_{SARA} is simply summed for one or more (e.g., all) gridcells within the treatment data map unit, such that:

RROI_{SARA,unit}=ΣRROI_{SARA,gridcell,unit}

These values are used within the Treatment ROI Optimization process to determine the best treatment for each landscape unit.

Calculate Pillar Value Effects

To estimate the quantified effects as percent change on the pillars over time, REASE values are updated for SARAs into the future (for example, 10, 20, and 30 years after treatment) and then redistributed and summed to the resilience pillars. For ecological SARAs, future REASE values can be calculated by simulating forest vegetation response and succession to treatments and disturbance over longer periods of time (e.g., using programs such as Forest Vegetation Simulator (FVS) software, a Landscape Disturbance and Succession Model (LDSM)). Then, key metrics output from the vegetation modeling that relate to that SARAs current functional condition are identified to track relative change compared to the year 0 value. The future SARA REASE values are then updated for each time period (for example, at 10, 20, and 30 years after treatment compared to year 0) and aggregated into the 10 pillars based on the SARA pillar contribution framework described in phase 2.

Stage 5: Application for Project Orientation and Sequencing

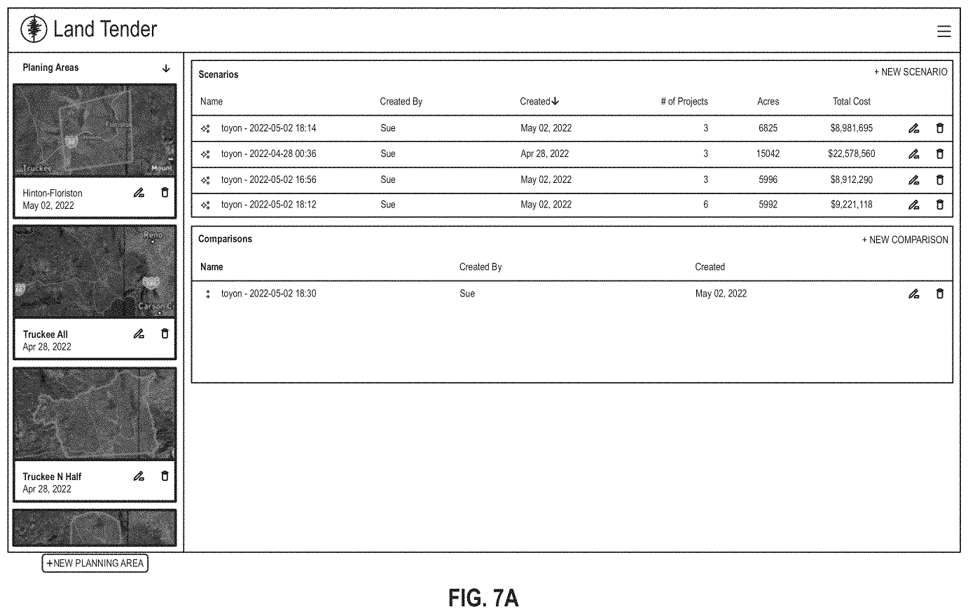

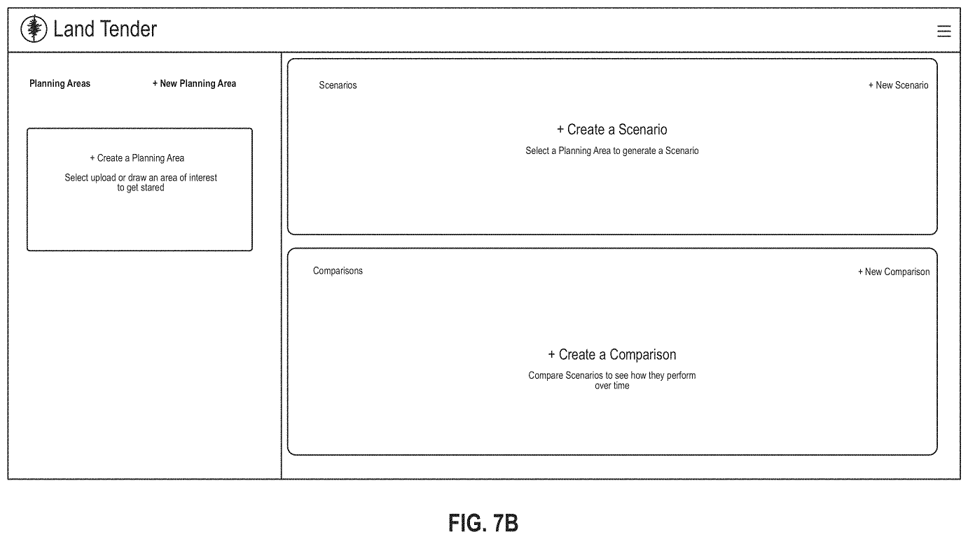

The application was developed for stakeholder groups, land managers, local, state, and federal agencies, and anyone with jurisdiction or interest in land planning processes to easily be able to visualize and plan forest health treatment projects. The application leverages the data developed in Stages 1-4. Users can interact with the data through three different screens in the user-interface (UI): Planning Area, Scenario Planning, and Scenario Comparison. Upon logging in, the user is greeted by a dashboard where they can access the three different areas of the UI, as shown in FIGS. 7A and 7B.

The Planning Area screen displays a map on which the user can draw or import a Planning Area. A Planning Area is an area of interest specific to the user, such as a watershed or an area around a community. In addition to drawing or importing a Planning Area, the user can visualize different datasets developed during Stages 1-4. A subset of the data used to create the Stewardship Atlas can be visualized by the user in the Planning Area screen. In some embodiments, there are three different types of data that the user can visualize within the Planning Area Screen: SARAs, Disturbance, and Economics. User may be provided a variety of controls that allow them to inspect different data layers to visualize spatial extent.

In some embodiments, users can toggle on and off different SARA data layers to visualize the spatial extent of the SARAs, and adjust the transparency of the layers to better visualize areas of overlapping SARAs. As one non-limiting example, for Disturbance data layers, the user can toggle on and off mapped information regarding fire and drought hazard (exposure×intensity) to see which areas within their landscape face the greatest hazard of these different disturbances. In some embodiments, the user can toggle on and off mapped information for each of the Resilience Pillars about “value” (e.g., SARA current value such as REASE (see description in the context of Stage 4) distributed across the Resilience Pillars) and “risk” (e.g., total exposure of value to one or more (e.g., all) disturbance hazards (see description in context of Stage 4). The user can see cumulative value and risk, or value and risk for each of the Resilience Pillars.

By visualizing this information, the user can examine the locations, extent, and value of resources distributed across the landscape. This information informs the user the location, value, and risk of these resources, thereby helping the user decide which areas to focus treatment.

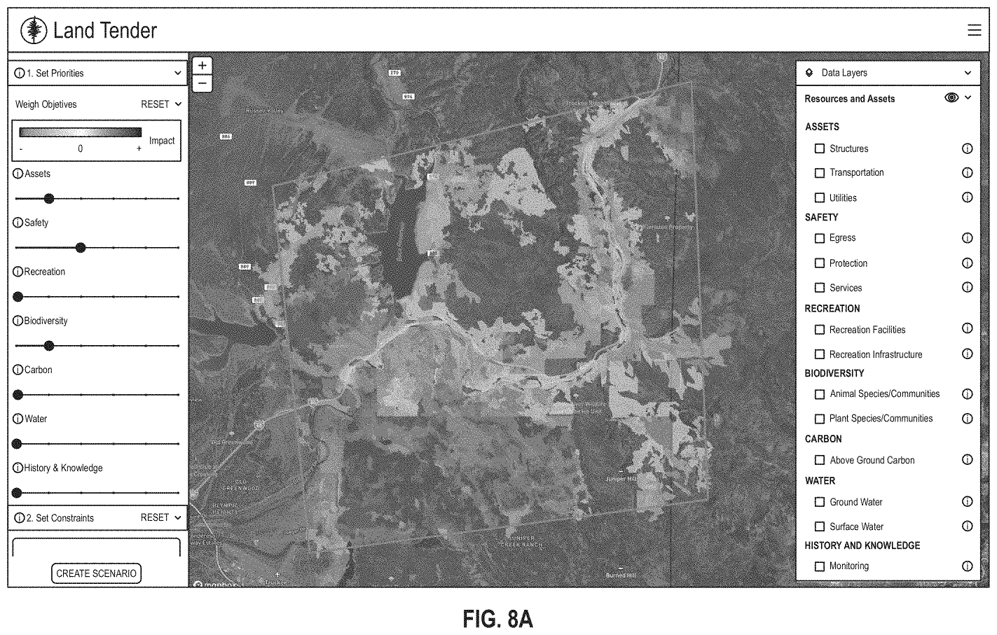

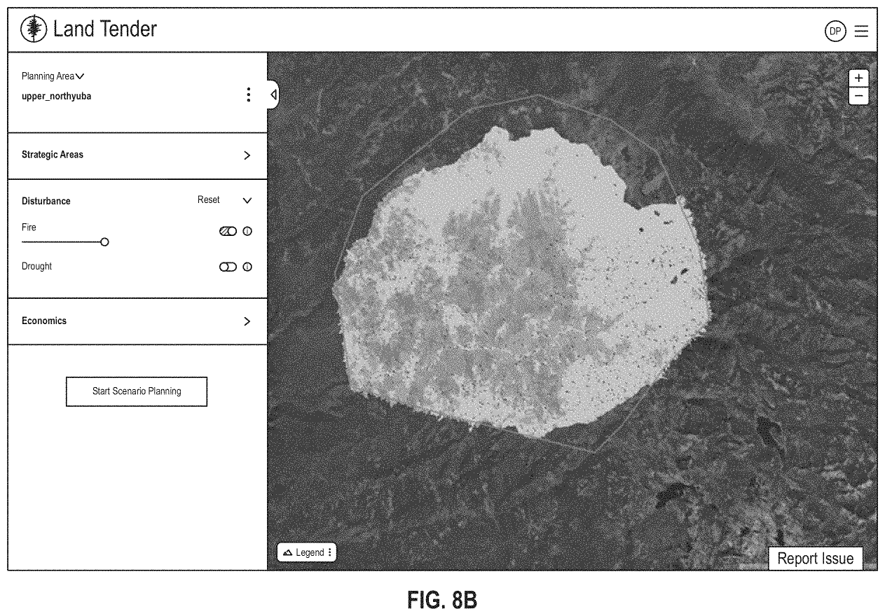

FIGS. 8A and 8B depict example user interfaces, in accordance with some embodiments. The planning process begins within the Scenario Planning screen. This screen allows users to weigh the Prioritization Objectives based on their unique management goals. The first step in this process is to view the user's selected priorities in a heatmap across the entire planning area. In some embodiments, this step may comprise developing a non-spatially optimized project, in which project areas are not grouped and stewardship data map polygons are simply prioritized in terms of their ability to maximize pillar RROI based on the user-input weights. The user is able to weigh each of the objectives on a scale from 0 to 5, with 5 being most important. Based on the assigned weight, each polygon in the stewardship data map is assigned a weighted cumulative return on investment. In some embodiments, the pillar ROIs for a given polygon are weighted based on the user-specified priorities and aggregated into a single value.

This is unlike conventional systems and methods, which do not allow the user to visualize different types of data (the spatial extent of SARAs, Disturbance, and Economics). When a user wants to assess and compare different treatment scenarios, the user can activate or deactivate viewing (e.g., visually overlaying) one or more data layers to assess the corresponding mapped information. In some embodiments, the different treatment scenarios may be according to the user-specific objectives. When the user wants to assess different scenarios, the user may adjust the weights of the objectives. When the objectives are adjusted, the disclosed systems and methods may be update the calculated performance metrics and heatmap displayed on the users interface, so that the user is able to visualize the impact the adjusted objectives have on the performance metrics. This ensures that the user is given immediate feedback so that the user can readily adapt the treatment strategy in accordance with the user's objectives.

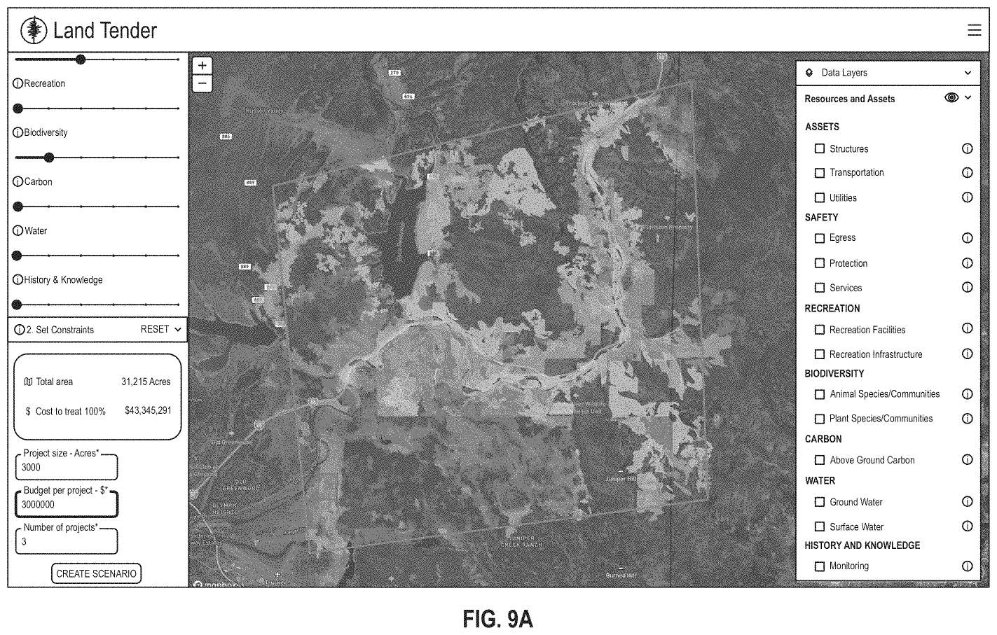

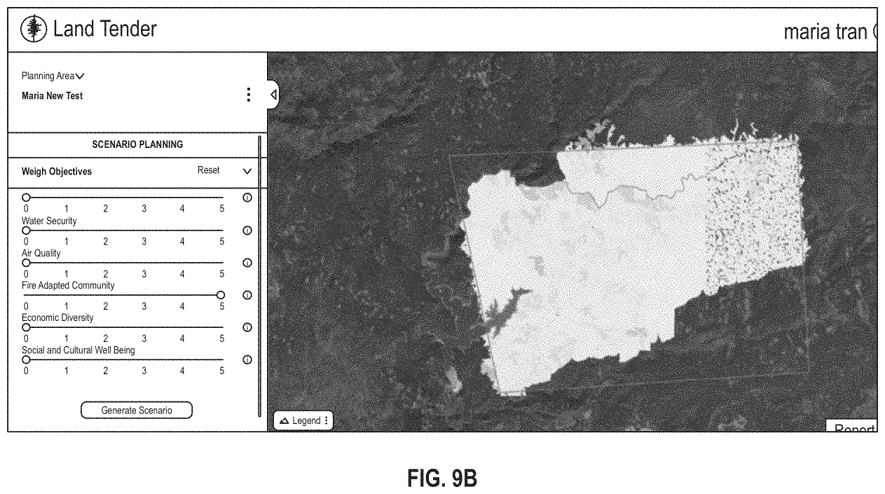

FIGS. 9A and 9B show example outputs from a non-spatially optimized scenario. In this scenario, the Assets pillar was weighted at a 1, Safety pillar weighted at a 2, and Biodiversity pillar was weighted at a 1. The mapped outputs visualize how weighting the pillars differently generates different shades of polygons that are reflective of their weighted RROI. The darker polygons have higher values than the lighter shaded polygons.

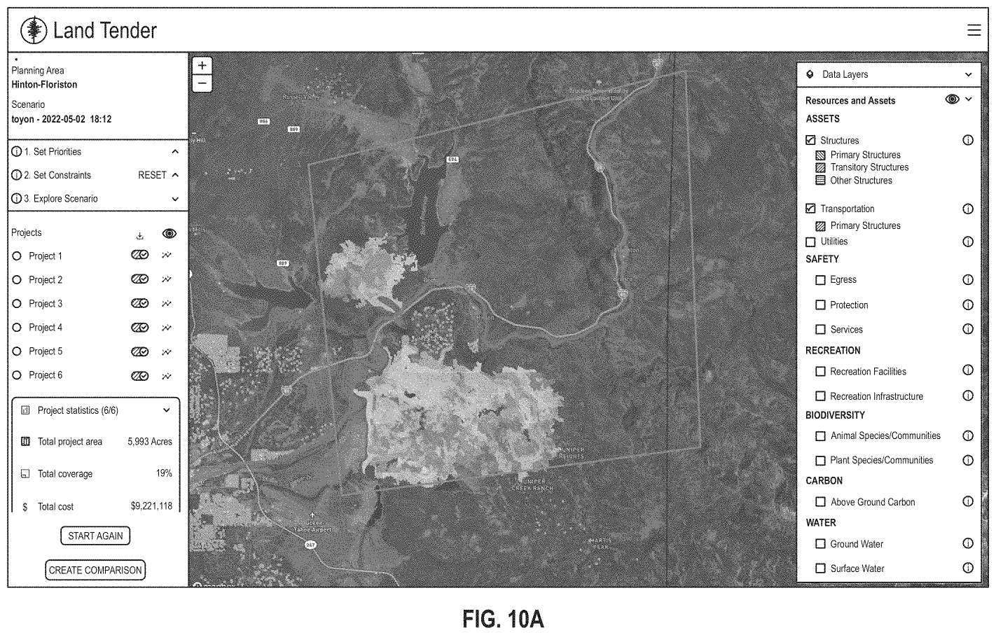

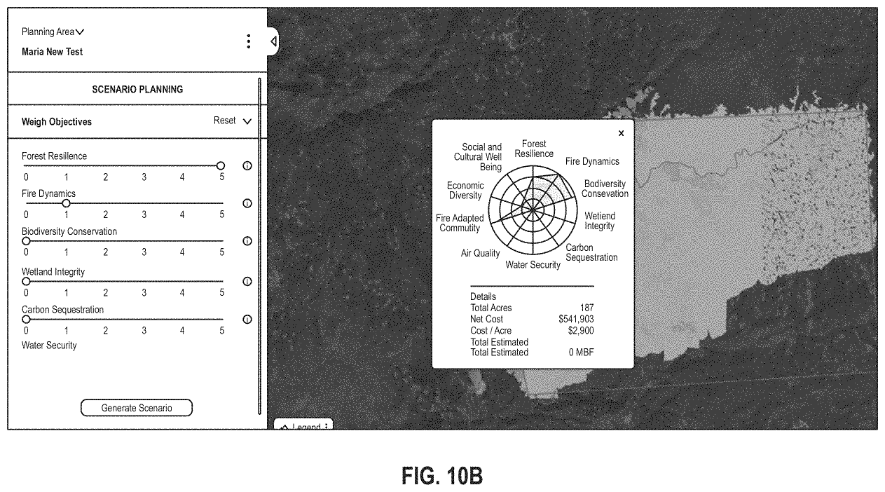

FIGS. 10A and 10B show example outputs from a non-spatially optimized scenario. In this scenario, the Fire Adapted Communities pillar was weighted at a 5, Forest Resilience pillar weighted at a 5, and Fire Dynamics pillar was weighted at a 1. The mapped outputs visualize how weighting the pillars differently generates different shades of polygons that are reflective of their weighted RROI (e.g., SPV). The darker polygons have higher values than the lighter shaded polygons, as confirmed and shown in the second screenshot below which highlights a higher value polygon.

The weighted scenario produces a spatial dataset with cumulative weighted RROIs identified as objectives. The project area development then occurs after this initial non-spatially optimized calculation of cumulative weighted RROIs. The user is prompted to input information about the number of projects they would like to generate, their budget per project, and a target acreage for each project. In some embodiments, the system then uses the scenario modeling (e.g., the platform ForSys or other similar prioritization algorithms/techniques) to develop spatially-optimized projects using the user-inputs. The scenario model may analyze prioritization problems at multiple scales ranging from planning areas to districts, forests and regions.

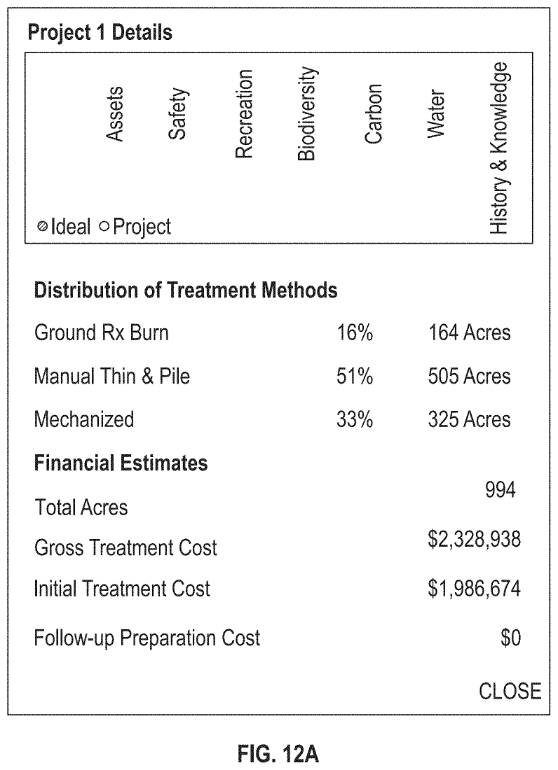

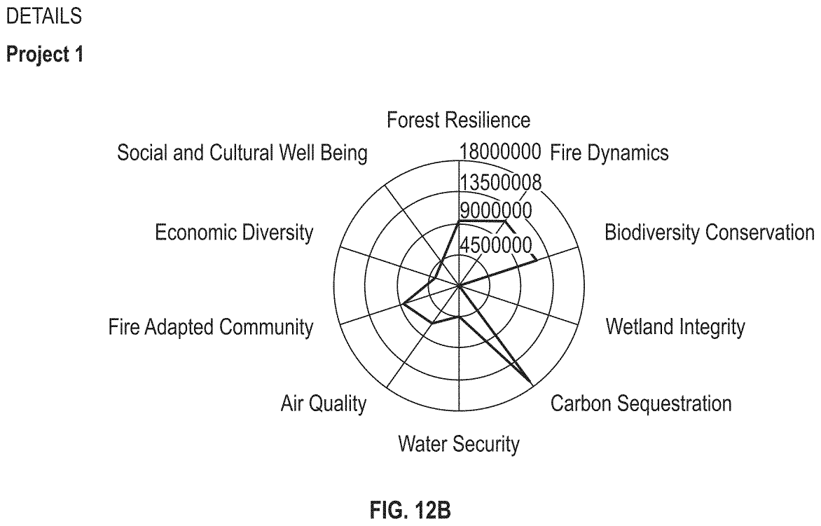

The optimized scenario provides a project summary for each project identified based on what was identified in the optimization screen. Project 1 will be the priority project based on cumulative weighted RROI. In some embodiments, the project summary provides a spider chart display of the sum of RROI associated with each pillar for the polygons identified for the individual project in the optimized scenario run. There are also summary tables provided with information about treatment costs, methods, and ownership for the individual project in the optimized scenario run. FIGS. 12A and 12B are examples of projects that were spatially-optimized in the application.

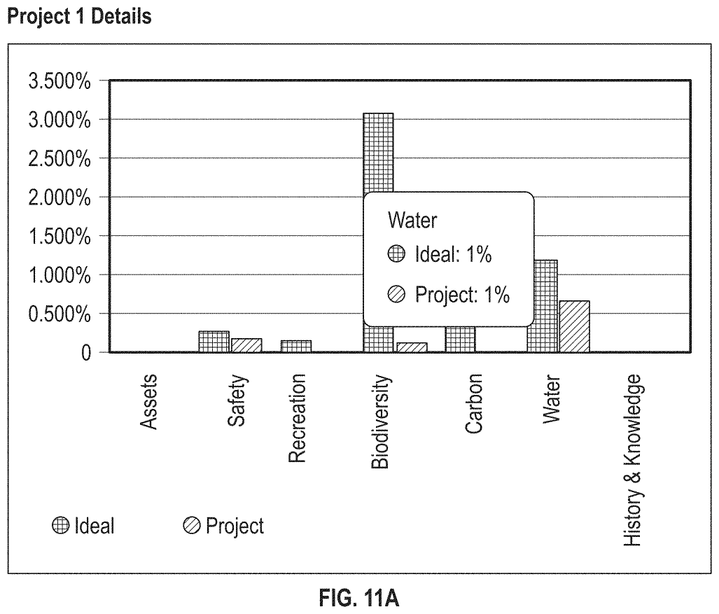

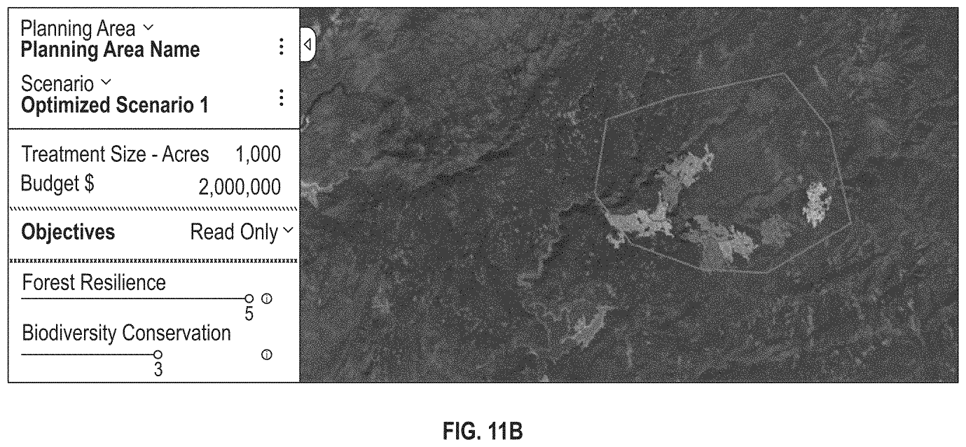

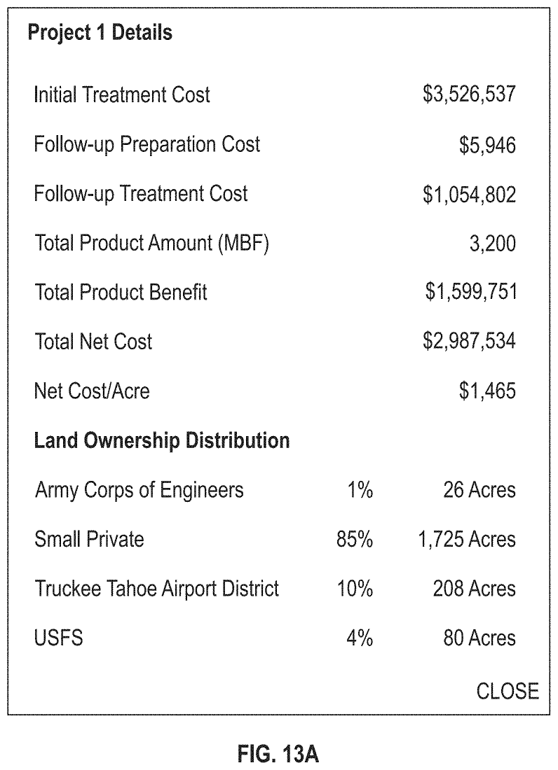

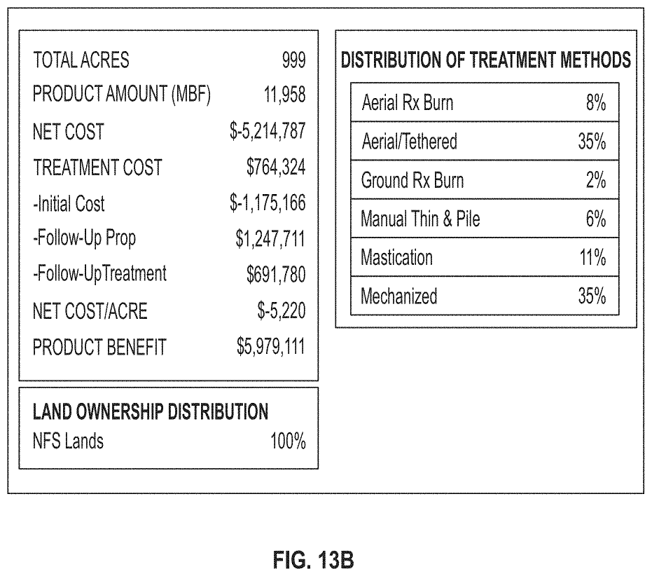

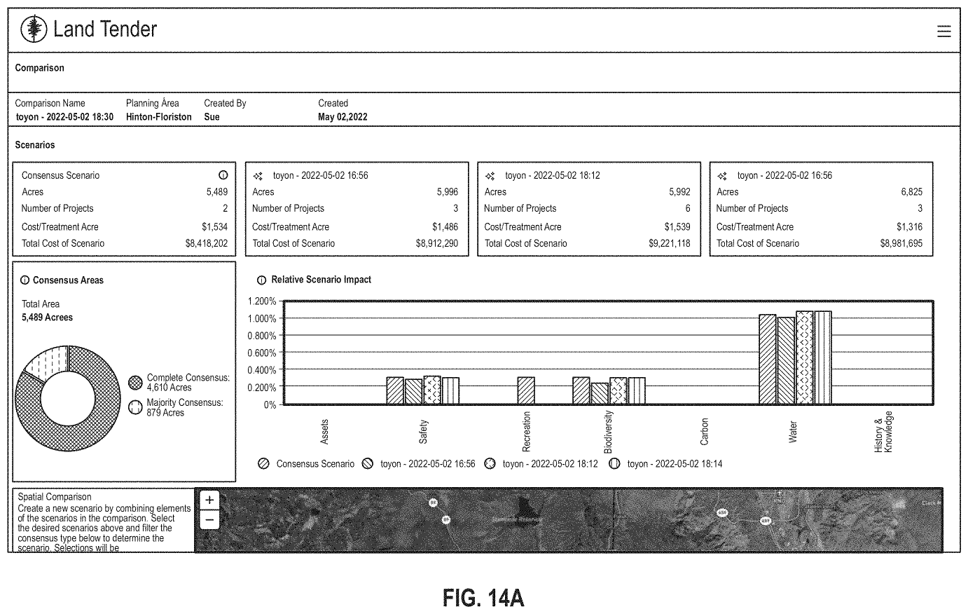

The user can also visualize information and metrics for each project of the scenario. FIGS. 11A, 11B, 12A, 12B, 13A, and 13B are screenshots of the project details pop up. FIG. 11A depicts a bar chart comparing the project benefit to the whole planning area as compared to idealized projects per pillar (where the ideal is not constrained to adjacency and is selected for only the labeled pillar). FIG. 12A depicts the recommended treatment prescription distribution. FIG. 13A depicts the financial project model and land ownership distribution.

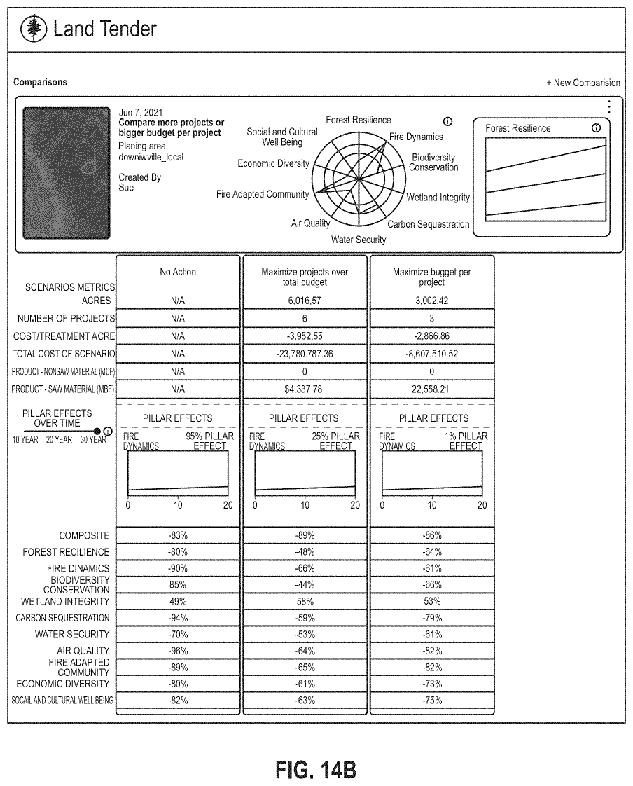

The Scenario Comparison screen (e.g., FIG. 14A or 14B) allows users to compare scenarios that they have developed with different parameters (e.g., pillar weights, project sizes and budgets, etc.) to determine the difference not only between scenario metrics such as cost, acreage, and pillar RROI, but also allows the user to compare the impact of the scenarios versus a no-action scenario. These estimated forecasted effects of vegetation treatments are represented as percent change in relative pillar socio-ecological value over time value over time, for example, at 10, 20, and 30 years into the future. Comparisons and metrics are visualized in dynamic figures and tables.

Sharing/Commenting

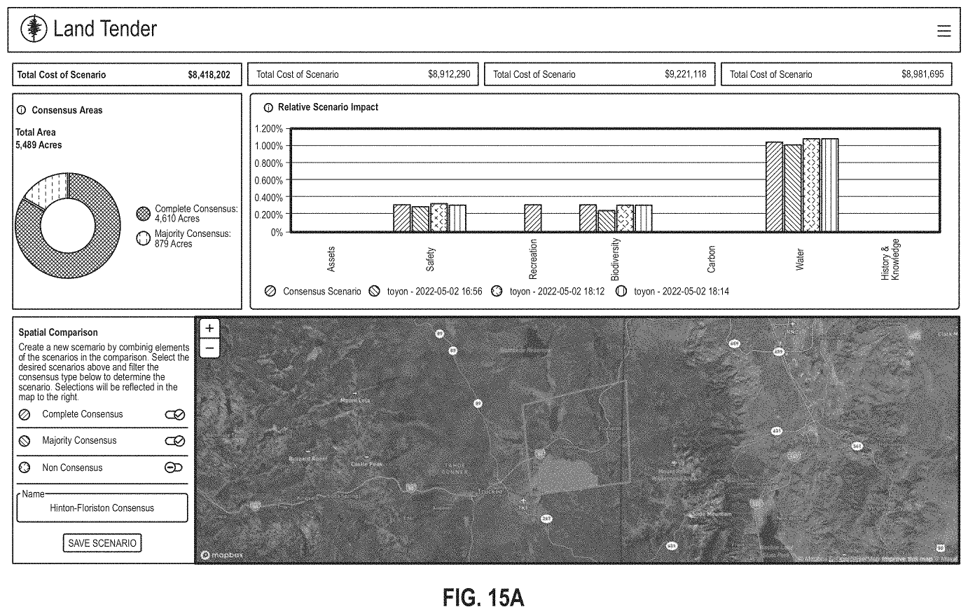

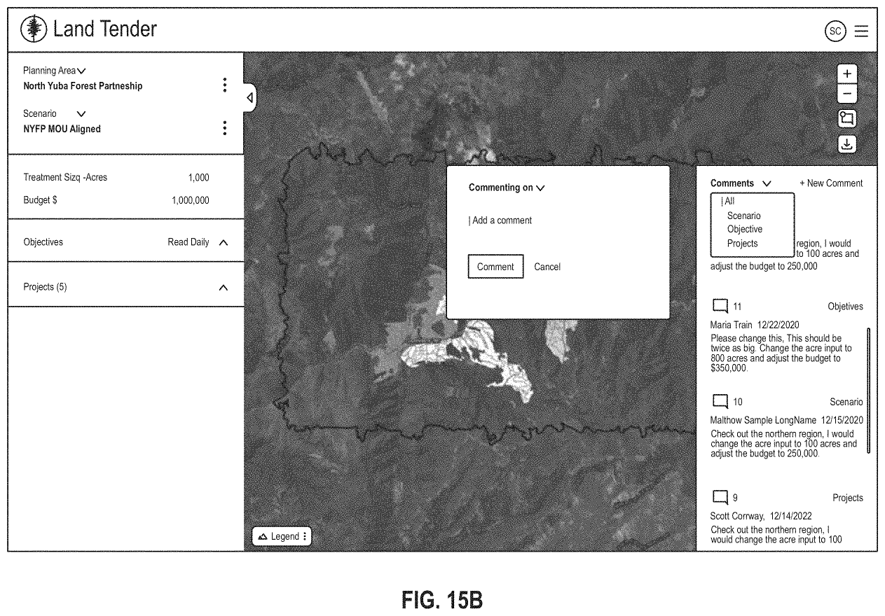

The system is a collaborative platform that supports users sharing their planning areas, scenarios, and comparisons with other users. Sharing any of these components allows another user who is signed into the application to view the work that was done by another user. Users can then collaborate and comment on different aspects of these artifacts (e.g., at the planning level, add comments about the boundaries of the area of interest, at the scenarios, comment on the weights of each scenario, at the comparison, comment on the scenarios being compared and their projected impacts). The platform facilitates multiple users collaborating, getting feedback and iterating on these artifacts to arrive at treatments that satisfy the project's needs. The platform serves as an interactive canvas for this discussion while maintaining a history of these comments and the changes that result from the discussion. FIGS. 15A and 15B depict an example user interface, in accordance with some embodiments.

Customized Project Planning Based on Ownership and Treatment Priorities

The user can also filter the landscape by ownership type to determine project development for the lands that they specifically manage or where they have cross-agency collaborative management opportunities. For example, the US Forest Service as a user may only be interested in developing projects on USFS lands, whereas a collaborative group may be interested in developing projects across its member's lands.

The user can also scale RROI to be more heavily weighted toward avoided loss (change in disturbance effects) or enhancement opportunity (treatment effects), depending on their management objectives and opportunities for funding. This allows them to generate and compare scenarios where their priority is more risk-based or opportunity-based. For example, a user may have an opportunity to access funding that is solely for risk management, in which case, they would be interested in more heavily weighting avoided loss in their project development process.

Optimizing Scenario Outputs

The system also allows the user to evaluate optimal project area scenarios for their Planning Area that maximize benefits for one or more (e.g., all) management objectives (e.g., pillar weights). Multi-objective search algorithms for parameter optimization can include techniques such as Monte Carlo simulations using random or quasi-random values within the parameter space to evaluate the optimal sets of solutions (e.g., scenarios containing project areas) on the Pareto front (Pareto optimal solution). The system also provides information not only about parameters associated with an optimal solution, but also allows the user to evaluate the uncertainty and sensitivity associated with each parameter for the development of project area scenarios.

Workforce Estimates

Besides estimating project costs, the system also estimates the workforce size, job roles, certifications, hours, and labor cost needed to complete a project and conduct routine maintenance treatments to keep the landscape within its desired condition. This is based on the types of treatments assigned and size of project areas. In some embodiments, the system then connects the user with contractors who specialize in implementation of the types of treatments needed for a given project area.

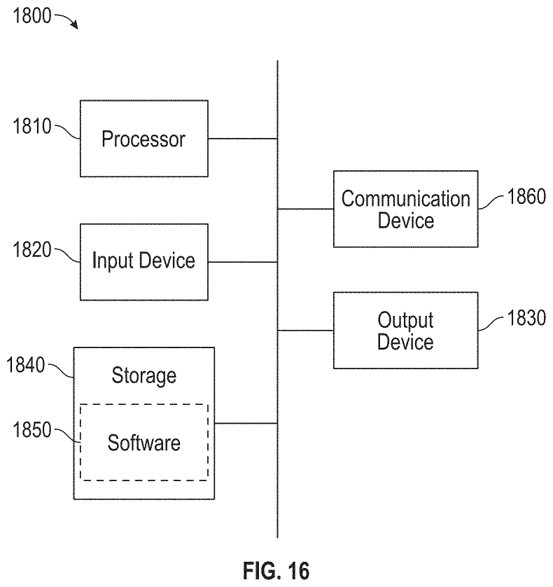

FIG. 16 illustrates an example of a computing device that can be used to perform any of the operations described herein, in accordance with one embodiment. Device 1800 can be a host computer connected to a network. Device 1800 can be a client computer or a server. As shown in FIG. 16, device 1800 can be any suitable type of microprocessor-based device, such as a personal computer, workstation, server or handheld computing device (portable electronic device) such as a phone or tablet. The device can include, for example, one or more of processor 1810, input device 1820, output device 1830, storage 1840, and communication device 1860. Input device 1820 and output device 1830 can generally correspond to those described above, and can either be connectable or integrated with the computer.

Input device 1820 can be any suitable device that provides input, such as a touch screen, keyboard or keypad, mouse, or voice-recognition device. Output device 1830 can be any suitable device that provides output, such as a touch screen, haptics device, or speaker.

Storage 1840 can be any suitable device that provides storage, such as an electrical, magnetic or optical memory including a RAM, cache, hard drive, or removable storage disk. Communication device 1860 can include any suitable device capable of transmitting and receiving signals over a network, such as a network interface chip or device. The components of the computer can be connected in any suitable manner, such as via a physical bus or wirelessly.

Software 1850, which can be stored in storage 1840 and executed by processor 1810, can include, for example, the programming that embodies the functionality of the present disclosure (e.g., as embodied in the devices as described above).

Software 1850 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1840, that can contain or store programming for use by or in connection with an instruction execution system, apparatus, or device.

Software 1850 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 1800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1800 can implement any operating system suitable for operating on the network. Software 1850 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A computer-implemented method of identifying a recommended treatment to a land, comprising:
identifying a plurality of sites of interest in the land;
segmenting the land into a plurality of units based on one or more of: ownership information or ecological information;
identifying, for a particular unit of the plurality of units, a plurality of potential treatments;
calculating a performance metric for each of the plurality of potential treatments to obtain a plurality of performance metrics for the particular unit, wherein each of the plurality of performance metrics is calculated based on one or more sites of interest located in the particular unit; and
selecting the recommended treatment for the particular unit of the land from the plurality of potential treatments based on the plurality of performance metrics.

2. The computer-implemented method of claim 1, further comprising: selectively collecting data related to the land, wherein the data comprises one or more of: anthropogenic data, physical data, or biologic data.

3. The computer-implemented method of claim 2, further comprising: generating, based on the collected data, map data indicating ownership and special land designation status of a plurality of portions of the land.

4. The computer-implemented method of claim 1, wherein the one or more sites of interest include one or more of: primary residential structures, non-residential structures, emergency infrastructure, utility infrastructure, water resources infrastructure, communication infrastructure, critical access roads, fuel breaks, strategic fuel areas, areas of critical plant and animal species habitat, large tree groves, nest and den sites, cultural sites, recreational trails, campgrounds, special/unique ecological features, ecological commodities, or scientific monitoring sites.

5. The computer-implemented method of claim 1, further comprising: performing disturbance assessment on the land to generate a plurality of disturbance maps corresponding to a plurality of disturbance types, wherein each of the plurality of disturbance maps includes one or more disturbance values for one or more sites of interest on the land.

6. The computer-implemented method of claim 1, further comprising: performing ecological function assessment on the land to determine treatment effects on the one or more sites of interest located in the particular unit, wherein each of the plurality of performance metrics for the particular unit is associated with the corresponding determined treatment effects.

7. The computer-implemented method of claim 1, wherein each of the plurality of units is owned by a single entity and has a uniform biophysical composition.

8. The computer-implemented method of claim 1, wherein the performance metric for each of the plurality of potential treatments is a treatment-specific restorative return on investment (RROI) value calculated by:
calculating one or more site-specific RROI values for the one or more sites of interest located in the particular unit; and
aggregating the one or more site-specific RROI values.

9. The computer-implemented method of claim 8, wherein each of the one or more site-specific RROI values is calculated based on a site-specific post-disturbance value change, a site-specific post-treatment post-disturbance value change, and a site-specific change in disturbance effects.

10. The computer-implemented method of claim 1, further comprising: calculating, for the recommended treatment, a contribution value of the recommended treatment for each of a plurality of objectives.

11. The computer-implemented method of claim 10, further comprising: obtaining one or more user inputs indicative of relative importance of the plurality of objectives.

12. The computer-implemented method of claim 1, further comprising:
formulating a plan for implementing the selected recommended treatment; and
displaying or automatically executing the plan.

13. The computer-implemented method of claim 1, further comprising: applying pillar contribution values to the one or more sites of interests located in the particular unit, wherein each pillar contribution value is based on resilience of the one or more sites of interest located in the particular unit to the corresponding pillar.

14. The computer-implemented method of claim 1, wherein identifying the plurality of potential treatments and selecting the recommended treatment are performed for each of the plurality of units.

15. The computer-implemented method of claim 14, further comprising:
receiving user inputs indicative of user selections of a plurality of scenarios, the plurality of scenarios associated with the plurality of units; and
providing a visual comparison of the plurality of scenarios.

16. The computer-implemented method of claim 15, wherein the user inputs further indicate priorities, the method further comprising:
weighting the plurality of scenarios in accordance with the priorities.

17. The computer-implemented method of claim 15, wherein at least one of the plurality of scenarios comprises a scenario created by another user.

18. The computer-implemented method of claim 1, further comprising: administering the recommended treatment to the particular unit of the land.

19. An electronic device, comprising:
one or more processors;
a memory; and
one or more programs, wherein the one or more programs are stored in the memory and configured to be executed by the one or more processors, the one or more programs including instructions for:
identifying a plurality of sites of interest in the land;
segmenting the land into a plurality of units based on one or more of: ownership information or ecological information;
identifying, for a particular unit of the plurality of units, a plurality of potential treatments;
calculating a performance metric for each of the plurality of potential treatments to obtain a plurality of performance metrics for the particular unit, wherein each of the plurality of performance metrics is calculated based on one or more sites of interest located in the particular unit; and
selecting the recommended treatment for the particular unit of the land from the plurality of potential treatments based on the plurality of performance metrics.

20. A non-transitory computer-readable storage medium storing one or more programs, the one or more programs comprising instructions, which when executed by one or more processors of an electronic device having a display, cause the electronic device to perform operations for:
identifying a plurality of sites of interest in the land;
segmenting the land into a plurality of units based on one or more of: ownership information or ecological information;
identifying, for a particular unit of the plurality of units, a plurality of potential treatments;
calculating a performance metric for each of the plurality of potential treatments to obtain a plurality of performance metrics for the particular unit, wherein each of the plurality of performance metrics is calculated based on one or more sites of interest located in the particular unit; and
selecting the recommended treatment for the particular unit of the land from the plurality of potential treatments based on the plurality of performance metrics.
